(19) United States
(12) Patent Application Publication
(10) Pub. No.: US 2026/0056430 A1
(43) Pub. Date: Feb. 26, 2026

(54) DISPLAY DEVICE AND ELECTRONIC DEVICE INCLUDING THE SAME

(71) Applicant: SAMSUNG DISPLAY CO., LTD., YONGIN-SI (KR)

(72) Inventors: Su Yeon SIM, Yongin-si (KR); Jeong Woo PARK, Yongin-si (KR); Su Bin JUNG, Yongin-si (KR); Beom Shik KIM, Yongin-si (KR); Young Chan KIM, Yongin-si (KR); Byeong Hee WON, Yongin-si (KR); Yu Kyung LEE, Yongin-si (KR)

(21) Appl. No.: 19/231,838

(22) Filed: Jun. 9, 2025

(30) Foreign Application Priority Data
Aug. 21, 2024 (KR) 10-2024-0112130

(51) Int. Cl. G02F 1/1335

(52) U.S. Cl. CPC G02F 1/133526; G02F 1/133512; G02F 1/133528; G02F 1/133553

(57) ABSTRACT

A display device includes a display panel, and an optical member disposed on the display panel. The optical member includes a base substrate, a polarization control portion disposed on the base substrate and configured to receive light incident from the display panel and output the light with one of a first linear polarization direction and a second linear polarization direction, a plurality of lenses disposed on the polarization control portion, a black matrix disposed on the polarization control portion and in a space between two adjacent lenses of the plurality of lenses, and a light reflection layer disposed between a side surface of the black matrix and each of the plurality of lenses. A refractive index of the light reflection layer is lower than a refractive index of each of the plurality of lenses.

### CROSS-REFERENCE TO RELATED APPLICATION

This application claims priority from Korean Patent Application No. 10-2024-0112130 filed on Aug. 21, 2024 in the Korean Intellectual Property Office, and all the benefits accruing therefrom under 35 U.S. C. 119, the contents of which in its entirety are herein incorporated by reference.

### BACKGROUND

### 1. Technical Field

The present disclosure relates to a display device, and an electronic device including the same.

### 2. Description of the Related Art

With the development of communication technology and media, display devices are being used to display images in various places and environments. In particular, various types of display devices such as a liquid crystal display (LCD) and an organic light emitting display (OLED) are widely used.

Recently, a stereoscopic image display device that divides and displays an image of a display device in a space on a front surface of the display device using a lens array has been developed. The stereoscopic image display device includes a binocular parallax method that separately displays a left eye image and a right eye image to create a sense of three-dimensionality according to a binocular parallax and a light field method that converges light emitted from each lens of the lens array into a viewing area where a viewer observes the display device. Accordingly, research is continuing on the stereoscopic image display device of the light field method that increases the number of view areas and displays more stereoscopic 3D images.

### SUMMARY

Aspects of the present disclosure provide a display device capable of increasing luminance of a stereoscopic image display device.

Aspects of the present disclosure also provide a manufacturing method of a display device capable of increasing luminance of a stereoscopic image display device.

According to an aspect of the present disclosure, a display device includes a display panel, and an optical member disposed on the display panel. The optical member includes a base substrate, a polarization control portion disposed on the base substrate and configured to receive light incident from the display panel and output the light with one of a first linear polarization direction and a second linear polarization direction, a plurality of lenses disposed on the polarization control portion, a black matrix disposed on the polarization control portion and in a space between two adjacent lenses of the plurality of lenses, and a light reflection layer disposed between a side surface of the black matrix and each of the plurality of lenses. A refractive index of the light reflection layer is lower than a refractive index of each of the plurality of lenses.

A lower surface of the black matrix may be wider than an upper surface of the black matrix.

The side surface of the black matrix may be a flat plane.

A side surface of the light reflection portion may be a flat plane.

An angle between the side surface of the light reflection layer and the lower surface of the black matrix may be 87° to 90°.

The polarization control portion may include a first driving electrode disposed below the plurality of lenses, a second driving electrode disposed below the first driving electrode, a liquid crystal layer disposed between the first driving electrode and the second driving electrode and a polarizing member disposed below the second driving electrode and in contact with an upper surface of the display panel. The polarizing member may polarize the light incident from the display panel to have the first linear polarization direction.

The liquid crystal layer may include a plurality of liquid crystal molecules. When a voltage difference between the first driving electrode and the second driving electrode is a predetermined value or less, long axes of the plurality of liquid crystal molecules are gradually aligned to from a first direction to a second direction perpendicular to the first direction between the first driving electrode and the second driving electrode. A long axis of at least one liquid crystal molecule, adjacent to the second driving electrode, of the plurality of liquid crystal molecules may be aligned to the first direction. A long axis of at least one liquid crystal molecule, adjacent to the first driving electrode, of the plurality of liquid crystal molecules may be aligned to the second direction. The liquid crystal layer may rotate the first linear polarization direction of the light incident from the display panel to the second linear polarization direction.

When the voltage difference between the first driving electrode and the second driving electrode is greater than the predetermined value, the long axes of the plurality of liquid crystal molecules are aligned to a third direction perpendicular to the first direction and the second direction. The polarizing member passes the light having the first linear polarization direction incident from the display panel so that a light outputted from the polarizing member has the first linear polarization direction.

The display panel may include a substrate, a thin film transistor layer disposed on the substrate, a light emitting element layer disposed on the thin film transistor layer, and an encapsulation layer disposed on the light emitting element layer.

According to an aspect of the present disclosure, a display device may include a display panel, and an optical member disposed on the display panel. The optical member may include a base substrate, a polarization control portion disposed on the base substrate and configured to receive light incident from the display panel and output the light with one of a first linear polarization direction and a second linear polarization direction, a plurality of lenses disposed on the polarization control portion, a black matrix disposed on the polarization control portion and between the plurality of lenses, and a light reflection layer disposed between a side surface of the black matrix and each of the plurality of lenses. The light reflection layer may include a metal that reflects light.

The side surface of the black matrix may be a flat plane.

A side surface of the light reflection portion may be a flat plane.

The side surface of the black matrix may be a curved surface.

A side surface of the light reflection layer may be a curved surface.

A distance, in a first direction, between an upper side of the light reflection layer and a central axis of a first lens, adjacent to the light reflection layer, among the plurality of lenses may be greater than a distance, in the first direction, between a lower side of the light reflection layer and the central axis of the first lens. The first direction may be parallel to an upper surface of the base substrate.

An amount of increase in distance between a portion of the side surface of the light reflection layer and the central axis of the first lens may decrease from the lower side to the upper side of the light reflection layer.

A distance between an upper side of the light reflection layer and a central axis of a first lens, adjacent to the light reflection layer, among the plurality of lenses may be the same as a distance between a lower side of the light reflection portion and the central axis of the first lens.

The light reflection layer may have a concave side surface which contacts the first lens. In a first direction, a central portion of the light reflection layer may be a portion spaced apart from the upper and lower sides of the light reflection layer by the same distance. A distance, in the first direction, between the central portion of the light reflection layer and the central axis of the lens may be greater than the distance, in the first direction, between the upper side of the light reflection layer and the central axis of the first lens.

Each of the plurality of lenses may include a plurality of liquid crystal molecules each of which has a long axis aligned in a first direction which is parallel to an upper surface of the base substrate.

The polarization control portion may include a polarizing member that polarizes the light incident from the display panel to have the first linear polarization direction.

According to an aspect of the present disclosure, an electronic device may include a processor, a memory having stored application programs for execution by the processor, and a display device. The display device includes a display panel, and an optical member disposed on the display panel. The optical member includes a base substrate, a polarization control portion disposed on the base substrate and configured to receive light incident from the display panel and output the light with one of a first linear polarization direction and a second linear polarization direction, a plurality of lenses disposed on the polarization control portion, a black matrix disposed on the polarization control portion and in a space between two adjacent lenses of the plurality of lenses, and a light reflection layer disposed between a side surface of the black matrix and each of the plurality of lenses. A refractive index of the light reflection layer is lower than a refractive index of each of the plurality of lenses. The electronic device further includes a user interface configured to sense user input via touch or cursor select of an icon presented on the display panel. The processor is caused to execute one or more of the stored application programs upon receipt of the user input.

However, aspects of the present disclosure are not restricted to those set forth herein. The above and other aspects of the present disclosure will become more apparent to one of ordinary skill in the art to which the present disclosure pertains by referencing the detailed description of the present disclosure given below.

According to the display device and the manufacturing method thereof according to some embodiments of the present disclosure, as a light reflection portion with a lower refractive index than a lens is provided on a side surface of a black matrix, some of the light traveling toward the black matrix may be totally reflected by the light reflection portion and emitted in a front direction of the display device. Accordingly, luminance of the display device may be improved.

According to the display device and the manufacturing method thereof according to some other embodiments of the present disclosure, as a light reflection portion including a metal that reflects light is provided on a side surface of a black matrix, some of the light traveling toward the black matrix may be totally reflected by the light reflection portion and emitted in a front direction of the display device. Accordingly, luminance of the display device may be improved.

However, the effects of the embodiments are not restricted to the one set forth herein. The above and other effects of the embodiments will become more apparent to one of daily skill in the art to which the embodiments pertain by referencing the claims.

### BRIEF DESCRIPTION OF THE DRAWINGS

The above and other aspects and features of the present disclosure will become more apparent by describing in detail embodiments thereof with reference to the attached drawings, in which:

FIG. 1 is an exploded perspective view illustrating a display device according to some embodiments of the present disclosure;

FIG. 2 is a perspective view of the display device of FIG. 1 according to some embodiments of the present disclosure;

FIG. 3 is a cross-sectional view of the display device taken along line I-I′ of FIG. 2 according to some embodiments of the present disclosure;

FIG. 4 is a cross-sectional view of the display device taken along line I-I′ of FIG. 2 according to some embodiments of the present disclosure;

FIG. 5 is a cross-sectional view illustrating area A of FIG. 3 according to some embodiments of the present disclosure ;

FIG. 6 is a cross-sectional view illustrating area A′ of FIG. 4 according to some embodiments of the present disclosure;

FIG. 7 is a cross-sectional view illustrating area A of FIG. 3 according to some embodiments of the present disclosure;

FIG. 8 is a cross-sectional view illustrating area A′ of FIG. 5 according to some embodiments of the present disclosure;

FIG. 9 is a cross-sectional view of the display device taken along line I-I′ of FIG. 2 according to some embodiments of the present disclosure;

FIGS. 10 and 11 are cross-sectional views illustrating area B of FIG. 9 according to some embodiments of the present disclosure;

FIG. 12 is a cross-sectional view of the display device taken along line I-I′ of FIG. 2 according to some embodiments of the present disclosure;

FIGS. 13 and 14 are cross-sectional views illustrating area C of FIG. 12 according to some embodiments of the present disclosure;

FIG. 15 is a cross-sectional view illustrating a substrate, a thin film transistor layer, a light emitting element layer, and an encapsulation film of FIG. 3 according to some embodiments of the present disclosure;

FIG. 16 is a flowchart for describing a manufacturing method of a display device according to some embodiments of the present disclosure;

FIGS. 17 to 23 are views for describing a manufacturing method of a display device according to some embodiments of the present disclosure; and

FIG. 24 is a block diagram illustrating an electronic device according to some embodiments of the present disclosure.

### DETAILED DESCRIPTION OF THE EMBODIMENTS

Advantages and features of the present disclosure and methods of achieving the same will become apparent with reference to the embodiments described below in detail in conjunction with the accompanying drawings. However, the present disclosure is not limited to embodiments to be described below, but may be implemented in various different forms, the present embodiments will be provided only in order to make the present disclosure complete and allow one of ordinary skill in the art to which the present disclosure pertains to completely recognize the scope of the present disclosure, and the present disclosure will be defined by the scope of the claims.

When an element or layer is referred to as being “on” another element or layer, it includes both a case in which the element or layer is directly on another element or layer and a case in which the element or layer is on another element or layer with the other element or layer interposed therebetween. The same reference numbers indicate the same components throughout the specification. Shapes, sizes, proportions, angles, numbers, and the like, disclosed in the drawings for describing embodiments are examples, and thus, the present disclosure is not limited to those illustrated in the drawings.

The individual features of the various embodiments of the present disclosure may be partially or wholly coupled or combined with each other, and may be technically linked and operated in various ways. The respective embodiments may be implemented independently of one another or may be implemented together in a related relationship.

The present inventive concept relates to a light reflection layer disposed in a space between a lens and a black matrix to increase a brightness of a display device. The light reflection layer has a refractive index lower than a refractive index of the lens such that an incident light from a display panel toward a front of display device can be totally reflected at an incident angle equal to or greater than a critical angle of total reflectance. The present inventive concept further relates to a light reflection layer including a metal which reflects the incident light toward the front of the display device.

Hereinafter, specific embodiments will be described with reference to the accompanying drawings.

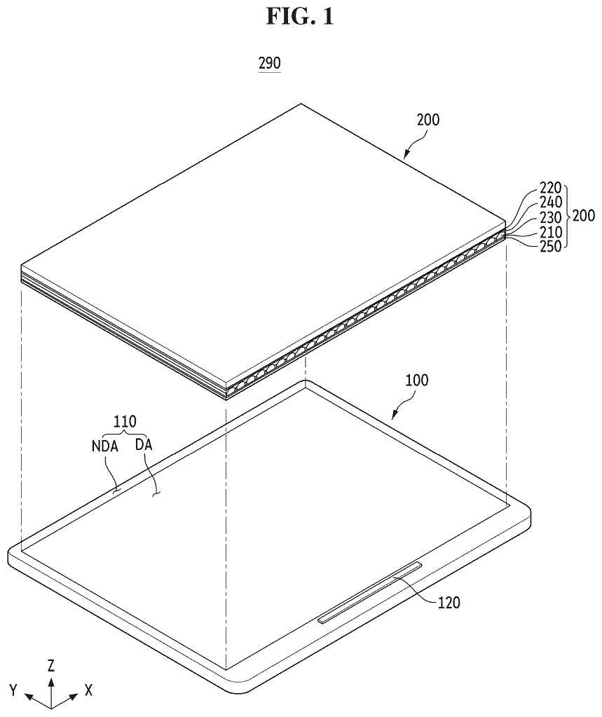

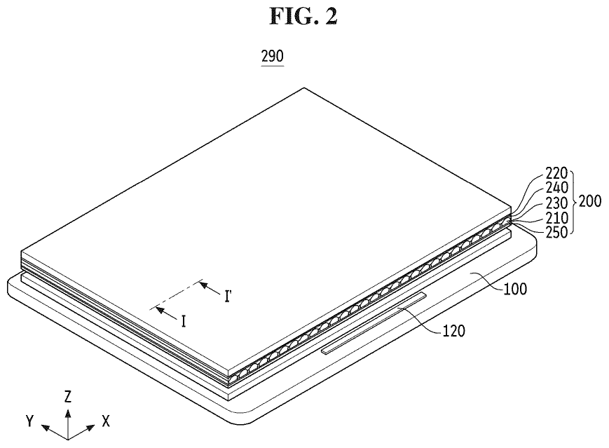

FIG. 1 is an exploded perspective view illustrating a display device according to some embodiments of the present disclosure. FIG. 2 is a perspective view of the display device of FIG. 1.

A display device 290 may be implemented as flat panel display devices such as a liquid crystal display (LCD), a field emission display (FED), a plasma display panel (PDP), and an organic light emitting display (OLED).

The display device 290 may be a stereoscopic image display device including a display module 100 and an optical member 200, for example, a 3D image display device. To display a 3D image, the stereoscopic image display device may separate and display a left-eye image and a right-eye image in a front direction to create a sense of three-dimensionality due to binocular parallax. The stereoscopic image display device may separate and provide a plurality of viewing angle images to the front surface of the display device so as to display different images for each of different viewing angles.

The display device 290 according to an embodiment may be a light field display device in which the optical member 200 is disposed on a front surface of the display module 100 to allow viewer's eyes to see different image information. The light field display device may generate a light field and create a 3D stereoscopic image by using a display module 100 that displays a two-dimensional (2D) image and an optical member 200 that converts the 2D image into a three-dimensional (3D) image and displays the 3D image. As will be described later, the light field display device causes image display light generated from each pixel of the display module 100 to form a light field directed in a specific direction (specific viewing angle and/or specific viewing point) by a stereoscopic lens, pinhole, or barrier included in the optical member 200. Accordingly, 3D stereoscopic image information corresponding to the specific direction may be provided to the viewer.

The display module 100 may include a display panel 110 and a display driver 120.

The display panel 110 may include a display area DA and a non-display area NDA. The display area DA may include data lines, scan lines, voltage supply lines, and a plurality of pixels connected to corresponding data and scan lines. For example, the scan lines may extend in a first direction (X-axis direction) and may be spaced apart from each other in a second direction (Y-axis direction). The data lines and the voltage supply lines may extend in the second direction (Y-axis direction) and may be spaced apart from each other in the first direction (X-axis direction).

Each pixel (or unit pixel) formed and arranged on the display panel 110 includes a number of sub-pixels capable of displaying a white color. For example, each pixel may include three sub-pixels that display red, green, and blue light, respectively. Each of the sub-pixels arranged alternately may be connected to at least one scan line, the data line, and the power supply line. Each of the sub-pixels may include thin film transistors including a driving transistor and at least one switching transistor, a light emitting element, and a capacitor. Each of the pixels may receive a data voltage of the data line when a scan signal is applied from the scan line, and may emit light by supplying a driving current to the light emitting element according to a data voltage applied to a gate electrode.

In the present disclosure, the pixels (e.g., unit pixels) of the display panel 110 display a two-dimensional multi view image according to the order of image data supply from the display driver 120. The multi view image includes n view images (where n is a natural number greater than or equal to 2), and here, the n view images are images generated by spacing n cameras apart by a distance between the eyes of an average person and taking an image of an object.

The display panel 110 may display the multi view image in units of n pixels during the image display period. For example, the display panel 110 may display the multi view image in units of two pixels. For example, two pixels of the display panel 110 may display a multi view image including two view images. In particular, the display panel 110 may display the multi view image in units of time-division frame (or sub-frame) periods according to a time-division driving of the display driver 120. In this case, the display panel 110 may display the multi view image in units of two pixels for each time-division frame period. The time-division frame period is a period in which one frame period is divided into ½ or ⅓ frame periods.

The non-display area NDA may surround the display area DA at an edge of the display panel 110. The non-display area NDA may include a scan driver (not illustrated) for applying scan signals to the scan lines and pads (not illustrated) connected to the display driver 120. For example, the display driver 120 may be disposed on one side of the non-display area NDA, and the pads may be disposed at an edge of one side of the non-display area NDA on which the display driver 120 is disposed.

The display driver 120 may output control signals and image data voltages for driving the display panel 110 in units of at least one frame or at least one time-division frame (or sub-frame). For example, the display driver 120 may supply the image data voltages to the data lines in units of at least one time-division frame (or sub-frame). The display driver 120 may supply a power voltage to the voltage supply line and may supply scan control signals to the scan driver.

The optical member 200 includes an optical lens portion (e.g., a refractive index anisotropic lens) 230 formed between first and second base substrates 210 and 220, a polarization control portion 250 formed by being stacked and overlapped with the first base substrate 210, and a filling layer 240 filled between the optical lens portion 230 and the second base substrate 220.

The display driver 120 may be formed as an integrated circuit (IC) and be disposed in the non-display area NDA of the display panel 110 in a chip on glass (COG) manner, a chip on plastic (COP) manner, or an ultrasonic bonding manner. As another example, the display driver 120 may be mounted on a circuit board (not illustrated) and connected to the pads of the display panel 110.

The optical member 200 may be disposed in a front direction of the display panel 110 or the display module 100. The optical member 200 may be attached to one surface of the display panel 110 or the display area DA through an adhesive member. The optical member 200 may be bonded to the front surface of the display module 100 by a separate panel bonding device.

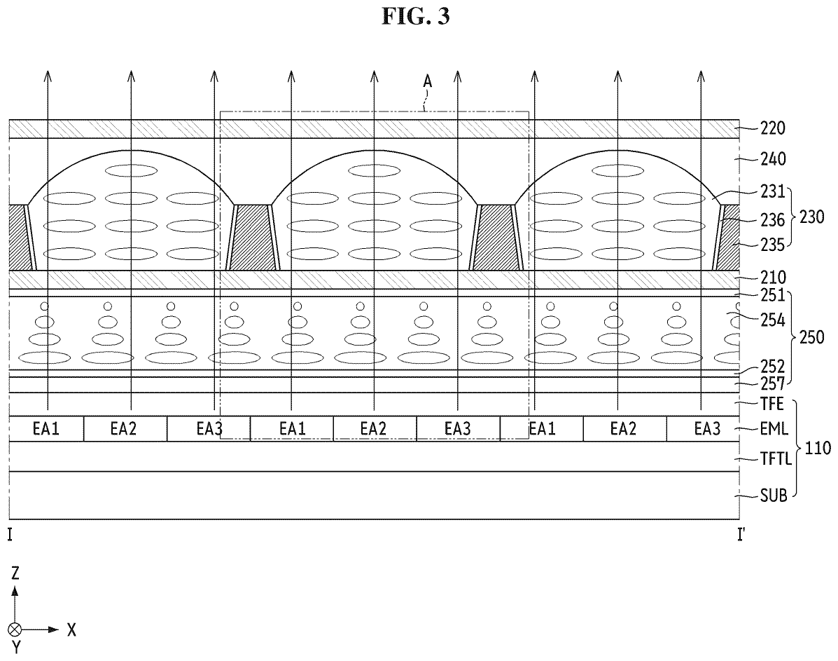

FIG. 3 is a cross-sectional view of the display device taken along line I-I′ of FIG. 2.

Referring to FIG. 3, the display panel 110 includes a substrate SUB, a thin film transistor layer TFTL, a light emitting element layer EML, and an encapsulation layer TFE.

The substrate SUB may be sufficiently rigid to support an element formed on the substrate SUB. For example, the substrate SUB may be a glass substrate or a plastic substrate such as polyethylene terephthalate (PET).

The thin film transistor layer TFTL may be disposed on the substrate SUB. The thin film transistor layer TFTL may adjust a brightness of the display device 290. The thin film transistor layer TFTL may include transistors.

The light emitting element layer EML may be disposed on the thin film transistor layer TFTL. The light emitting element layer EML may include first to third light emitting areas EA1, EA2, and EA3. The first to third light emitting areas EA1, EA2, and EA3 may be alternately disposed. In an embodiment, the first to third light emitting areas EA1, EA2, and EA3 may correspond to sub-pixels of a pixel which generate a white color.

The encapsulation layer TFE may be disposed on the light emitting element layer EML. The encapsulation layer TFE includes at least one inorganic film and at least one organic film for encapsulating the light emitting element layer EML.

The optical member 200 will be described in more detail. The optical member 200 may include a polarization control portion 250 and an optical lens portion 230 formed in a stacked and overlapped state between the first and second base substrates 210 and 220. The optical member 200 may include a filling layer 240 disposed between the second base substrate 220 and the optical lens portion 230.

The first and second base substrates 210 and 220 may include a material through which light may transmit, such as glass and plastic.

The polarization control portion 250 that filters and outputs light from the display panel 110 along a path in a first linear polarization direction or a second linear polarization direction is formed on a rear surface of the first base substrate 210 or a front surface of the display panel 110.

The polarization control portion 250 may pass light incident on the path in the first linear polarization direction through the substrate SUB by maintaining the path in the first linear polarization direction, or pass the light incident on the path in the first linear polarization direction through the substrate SUB by switching the light path to the path in the second linear polarization direction. For example, light incident on the path in the first linear polarization direction may mean light that vibrates in an X-axis direction, and light incident on the path in the second linear polarization direction may mean light that vibrates in a Y-axis direction. For example, light polarized in the first linear polarization direction (i.e., light having the first linear polarization direction) may oscillate in the X-axis direction perpendicular to a propagation direction (e.g., a Z-axis direction perpendicular to the X-axis direction and the Y-axis direction). Light polarized in the second linear polarization direction (i.e., light having the second linear polarization direction) may oscillate in the Y-axis direction perpendicular to the propagation direction (e.g., the Z-axis direction perpendicular to the X-axis direction and the Y-axis direction).

The polarization control portion 250 may include a first driving electrode 251, a second driving electrode 252, a driving liquid crystal 254 (i.e., a liquid crystal layer), and a polarizing member 257.

The first driving electrode 251 may be disposed on a lower portion of the first base substrate 210. An upper surface of the first driving electrode 251 may be in contact with a lower surface of the first base substrate 210. The first driving electrode 251 may receive a driving voltage from the display driver 120.

The second driving electrode 252 may be disposed on an upper portion of the display panel 110. The second driving electrode 252 may be disposed to be parallel to the first driving electrode 251. A shape of the second driving electrode 252 may be formed to correspond to a shape of the first driving electrode 251. In some embodiments, the first driving electrode 251 and the second driving electrode 252 may include a transparent conductive material such as Indium Tin Oxide (ITO), Fluorine-Doped Tin Oxide (FTO), Aluminum-Doped Zinc Oxide (AZO), Graphene, Silver Nanowires (AgNWs), and conductive polymers (e.g., PEDOT:PSS).

The polarizing member 257 may be disposed on a lower portion of the second driving electrode 252. The polarizing member 257 may be disposed on the upper portion of the display panel 110. A lower surface of the polarizing member 257 may be in contact with an upper surface of the display panel 110. The polarizing member 257 may pass light vibrating in a specific direction and block light vibrating in a direction different from the specific direction. Hereinafter, for convenience of explanation, it is assumed that the polarizing member 257 passes light vibrating in the first direction (X-axis direction) (i.e., the first linear polarization direction).

The driving liquid crystal 254 may be disposed between the first driving electrode 251 and the second driving electrode 252. The driving liquid crystal 254 may include a liquid crystal that is a birefringent material. In some embodiments, the driving liquid crystal 254 may include a plurality of liquid crystal molecules. The arrangement of the liquid crystal molecules of the driving liquid crystals 254 may change depending on a voltage difference between the first driving electrode 251 and the second driving electrode 252. For example, long axes of the liquid crystal molecules may be variously aligned depending on the voltage difference applied to the liquid crystal molecules.

Referring to FIG. 3, the polarization control portion 250 may convert light incident on a path in the first linear polarization direction through the substrate SUB into a path in the second linear polarization direction and pass the light during the 2D image display period in response to the driving control of the display driver 120.

Specifically, the display driver 120 may equally supply a first driving voltage to the first driving electrode 251 and the second driving electrode 252.

When the voltage difference between the first driving electrode 251 and the second driving electrode 252 is a predetermined value or less, a long axis of the liquid crystal in a lower portion of the driving liquid crystal 254 may be aligned in the first direction (X-axis direction). A long axis of the liquid crystal in an upper portion of the driving liquid crystal 254 may be aligned in the second direction (Y-axis direction). Between the upper and lower portions of the driving liquid crystal 254, the long axis of the liquid crystal may gradually change. For example, the driving liquid crystal 254 may be a twisted nematic (TN) liquid crystal. For example, the driving liquid crystal 254 (i.e., the liquid crystal layer) may include a plurality of liquid crystal molecules. When a voltage difference between the first driving electrode 251 and the second driving electrode 252 is a predetermined value or less, long axes of the plurality of liquid crystal molecules may be gradually aligned to from the first direction to the second direction between the first driving electrode 251 and the second driving electrode 252. A long axis of at least one liquid crystal molecule, adjacent to the second driving electrode 252, of the plurality of liquid crystal molecules may be aligned to or fixed to the first direction. A long axis of at least one liquid crystal molecule, adjacent to the first driving electrode 251, of the plurality of liquid crystal molecules may be aligned to or may be fixed to the second direction perpendicular to the first direction. The driving liquid crystal 254 may rotate a first linear polarization direction of the light incident from the display panel to a second linear polarization direction.

The light in the first linear polarization direction may be incident on the driving liquid crystal 254 from the polarizing member 257. The light in the first linear polarization direction may have its linear polarization direction changed along the liquid crystal whose long axis gradually changes. Therefore, the light in the first linear polarization direction may have its polarization direction converted into the light in the second linear polarization direction by the driving liquid crystal 254.

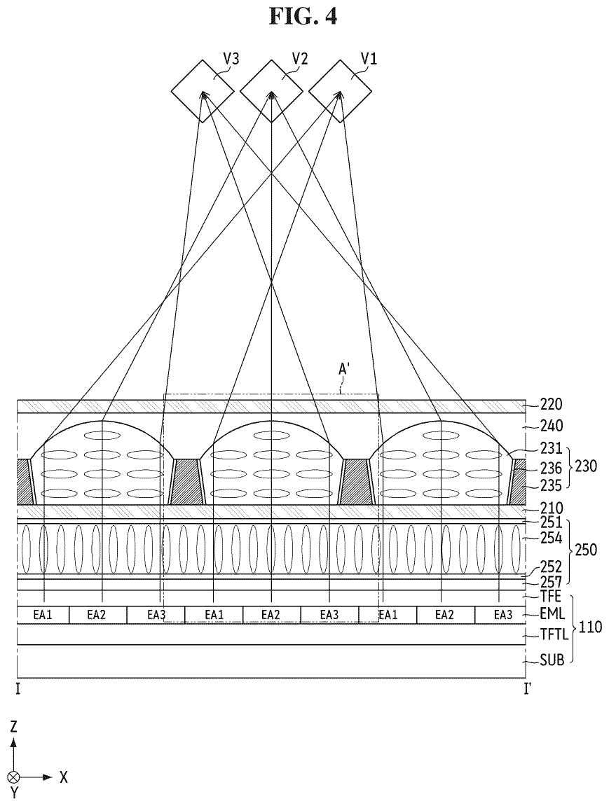

FIG. 4 is a cross-sectional view of the display device taken along line I-I′ of FIG. 2 according to some embodiments of the present disclosure. Referring to FIG. 4, the polarization control portion 250 may maintain and pass light incident on a path in the first linear polarization direction in response to the driving control of the display driver 120 during the 3D image display period.

When the voltage difference between the first driving electrode 251 and the second driving electrode 252 is greater than a predetermined value, all liquid crystals of the driving liquid crystal 254 may be aligned in the third direction (Z-axis direction).

As in FIG. 3, the light in the first linear polarization direction may be incident on the driving liquid crystal 254 from the polarizing member 257. However, unlike FIG. 3, in FIG. 4, the light in the first linear polarization direction may pass through the liquid crystal whose long axis is aligned in the third direction (Z-axis direction). For example, the incident light in the first linear polarization direction may be output while maintaining the first linear polarization direction even when passing through the driving liquid crystal 254.

The optical lens portion 230 may be disposed on the first base substrate 210. The optical lens portion 230 may be arranged in parallel and formed in the form of a lens sheet. The first base substrate 210 may be disposed in a laminated and overlapped state with the optical lens portion 230 formed in the form of the lens sheet.

The optical lens portion 230 includes a plurality of lenses 231, a black matrix 235, and a light reflection portion 236 (i.e., a light reflection layer).

The plurality of lenses 231 may be configured and disposed to form the path in the first linear polarization direction according to the arrangement of birefringent materials (e.g., liquid crystals or slits) included in the plurality of lenses 231.

Referring to FIG. 3, the plurality of lenses 231 may directly pass the light that has been converted to the path in the second linear polarization direction through the polarization control portion 250 during the 2D image display period.

Referring to FIG. 4, when the light in the path in the first linear polarization direction is incident on the plurality of lenses 231 through the polarization control portion 250 during the 3D image display period, the light in the first linear polarization direction is refracted in directions of preset view areas V1, V2, and V3 by the arrangement of lens forming materials or birefringent materials, and displayed as a 3D image.

The plurality of lenses 231 maintains and passes light incident on the path in the second linear polarization direction. For example, the plurality of lenses 231 may pass light polarized in the second linear polarization direction (i.e., light having the second linear polarization direction). The plurality of lenses 231 refract the light incident on the path in the first linear polarization direction into preset view areas V1, V2, and V3, respectively, and emits the light. In some embodiments, each of the plurality of lenses 231 may direct the light polarized in the first linear polarization direction into the preset view areas V1, V2, and V3. For example, FIG. 4 shows three lenses including a left lens, a right lens, and a center lens therebetween. The left, right, and center indicate locations of the three lenses in FIG. 4 as shown. The left lens may refract three light rays having a first light ray refracted to (i.e., bent toward) the view area V1, a second light ray refracted to the view area V2, and a third light ray refracted to the view area V3. The other lenses may refract multiple light rays to the view areas V1, V2, and V3. Accordingly, a 3D stereoscopic image is displayed through the plurality of lenses 231 during the 3D image display period.

The black matrix 235 may be disposed between the plurality of lenses 231. The black matrix 235 may include a light absorbing material that absorbs light. For example, the light absorbing material may be a black dye or black pigment. The black matrix 235 may absorb light between the plurality of lenses 231. Through this, the black matrix 235 may prevent crosstalk from occurring due to diffraction of light at a boundary portion of the plurality of lenses 231.

When viewed in a plan view, a length of a lower surface of the black matrix 235 may be longer than a length of an upper surface of the black matrix 235. For example, the lower surface of the black matrix 235 may be wider than the upper surface of the black matrix 235. A side surface of the black matrix 235 may be formed as a flat plane. For example, the black matrix 235 may be formed in a trapezoidal shape.

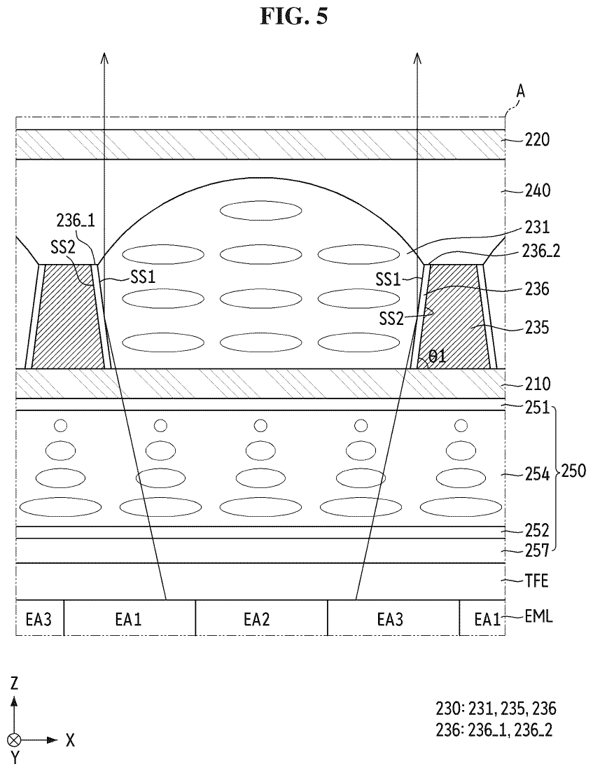

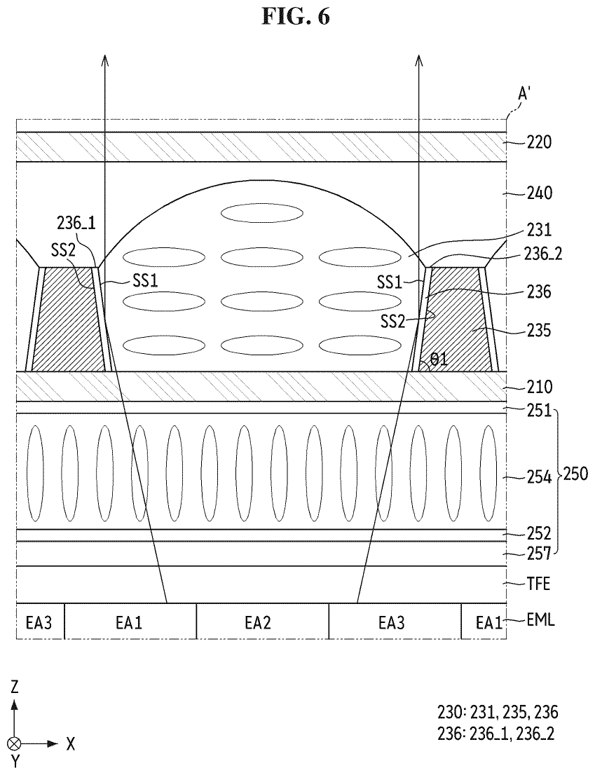

The light reflection portion 236 may be disposed between the plurality of lenses 231 and the black matrix 235 to reflect light traveling from the light emitting areas EA1, EA2, and EA3 toward the black matrix 235. A detailed description of the light reflection portion 236 will be described later with reference to FIGS. 5 and 6.

The filling layer 240 may be disposed on the plurality of lenses 231, the black matrix 235, and the light reflection portion 236. The second base substrate 220 may be disposed on the filling layer 240.

The filling layer 240 may include a transparent material through which light may transmit. For example, the filling layer 240 may include an isotropic polymer.

A refractive index of the filling layer 240 may be the same as a refractive index in a short axis direction of the liquid crystals included in the plurality of lenses 231. Accordingly, depending on the polarization direction of the light passing through the plurality of lenses 231, refraction may or may not occur at an interface between the plurality of lenses 231 and the filling layer 240.

For example, when the polarization direction of the light passing through the plurality of lenses 231 is identical to the long axis direction (e.g., X-axis direction) of the liquid crystals included in the plurality of lenses 231, the refraction may occur at the interface between the plurality of lenses 231 and the filling layer 240.

When the polarization direction of the light passing through the plurality of lenses 231 is identical to the short axis direction (e.g., Z-axis direction) of the liquid crystals included in the plurality of lenses 231, the refraction may not occur at the interface between the plurality of lenses 231 and the filling layer 240.

FIG. 5 is a cross-sectional view illustrating area A of FIG. 3.

Referring to FIG. 5, the light reflection portion 236 may be disposed between the plurality of lenses 231 and the black matrix 235. A first side surface SS1 of the light reflection portion 236 may be in contact with the plurality of lenses 231, and a second side surface SS2, which is an opposite surface of the first side surface SS1, may be in contact with the black matrix 235. The light reflection portion 236 may totally reflect light incident at a predetermined critical angle or more by including a material having a lower refractive index than the plurality of lenses 231. For example, the light reflection portion 236 may totally reflect light incident at an incident angle relative to a normal direction of a side surface of the light reflection portion 236 when the incident angle is equal to or greater than a critical angle for total reflectance according to the Snell's law. The Snell's law describes a condition when an incident light is totally reflected.

The light reflection portion 236 may include at least one of an acryl resin, an epoxy resin, a phenolic resin, a polyamide resin, and a polyimide resin having a lower refractive index than the plurality of lenses 231.

The first side surface SS1 of the light reflection portion 236 may correspond to a side surface of the black matrix 235. A shape of the first side surface SS1 of the light reflection portion 236 may follow a shape of the side surface of the black matrix 235. When the shape of the side surface of the black matrix 235 has a flat plane shape, the shape of the first side surface SS1 of the light reflection portion 236 may also have a flat plane shape. An angle formed by the first side surface SS1 of the light reflection portion 236 and a lower surface of the black matrix 235 may be the same as an angle formed by the second side surface SS2 of the light reflection portion 236 and the lower surface of the black matrix 235. When viewed in a plan view, the light reflection portion 236 may be formed so that a length of the upper surface and a length of the lower surface are the same. For example, the upper surface of the light reflection portion 236 and the lower surface of the light reflection portion 236 may be the same in width measured in the X-axis direction.

An angle θ1 formed by the second side surface SS2 of the light reflection portion 236 and the lower surface of the black matrix 235 may be 87° to 90°. However, the present embodiment is not limited to the above-mentioned angle, and the specific shapes of the black matrix 235 and the light reflection portion 236 may be modified so that an occurrence of crosstalk at a boundary of the plurality of lenses 231 may be minimized.

During the 2D image display period, the light reflection portion 236 may totally reflect light incident on the first side surface SS1 of the light reflection portion 236 at an angle of the critical angle or more. For example, the light reflection portion 236 may totally reflect light incident at an incident angle relative to a normal direction of the first side surface SS1 of the light reflection portion 236 when the incident angle is equal to or greater than a critical angle for total reflectance according to the Snell's law.

The light reflection units 236 in contact with one of the plurality of lenses 231 may include a first light reflection portion 236_1 and a second light reflection portion 236_2. The first light reflection portion 236_1 may be disposed to be adjacent to the first light emitting area EA1 overlapping the lens 231 compared to the second light reflection portion 236_2. The second light reflection portion 236_2 may be disposed to be adjacent to the third light emitting area EA3 overlapping the lens 231 compared to the first light reflection portion 236_1.

The drawing illustrates an example in which one lens 231 overlaps one first light emitting area EA1, one second light emitting area EA2, and one third light emitting area EA3, but the present embodiment is not limited thereto. One lens 231 may overlap a plurality of first light emitting areas EA1, a plurality of second light emitting areas EA2, and a plurality of third light emitting areas EA3. Alternatively, the number of first light emitting areas EA1, the number of second light emitting areas EA2, and the number of third light emitting areas EA3 overlapping one lens 231 may be different from each other.

Since light emitted from the first light emitting area EA1 overlapping the lens 231 is incident on a first side surface SS1 of the first light reflection portion 236_1 disposed to be adjacent to the first light emitting area EA1 at an angle of the critical angle or more, the light may be totally reflected on the first side surface SS1 of the first light reflection portion 236_1 and emitted to the outside of the display device 290. For example, the first side surface SS1 of the first light reflection portion 236_1 may totally reflect light incident at an incident angle relative to a normal direction of the first side surface SS1 of the first light reflection portion 236_1 when the incident angle is equal to or greater than a critical angle for total reflectance according to the Snell's law. It is difficult for the light emitted from the first light emitting area EA1 overlapping the lens 231 to be incident on a first side surface SS1 of the second light reflection portion 236_2 disposed apart from the first light emitting area EA1 at the angle of the critical angle or more. For example, the light emitted from the first light emitting area EA1 may be incident on the first side surface SS1 of the second light reflection portion 236_2 at an incident angle less than the critical angle for total reflectance, and thus no total reflection occurs. Therefore, among the light emitted from the first light emitting area EA1 overlapping the lens 231, the amount of light that is totally reflected from the first side surface SS1 of the second light reflection portion 236_2 and emitted to the outside of the display device 290 may be very small.

Since light emitted from the third light emitting area EA3 overlapping the lens 231 is incident on a first side surface SS1 of the second light reflection portion 236_2 disposed to be adjacent to the third light emitting area EA3 at an angle of the critical angle or more, the light may be totally reflected on the first side surface SS1 of the second light reflection portion 236_2 and emitted to the outside of the display device 290. For example, the first side surface SS1 of the second light reflection portion 236_2 may totally reflect light incident at an incident angle relative to a normal direction of the first side surface SS1 of the second light reflection portion 236_2 when the incident angle is equal to or greater than a critical angle for total reflectance according to the Snell's law. It is difficult for the light emitted from the third light emitting area EA3 overlapping the lens 231 to be incident on a first side surface SS1 of the first light reflection portion 236_1 disposed apart from the third light emitting area EA3 at the angle of the critical angle or more. For example, the light emitted from the third light emitting area EA3 may be incident on the first side surface SS1 of the first light reflection portion 236_1 at an incident angle less than the critical angle for total reflectance, and thus no total reflection occurs. Therefore, among the light emitted from the third light emitting area EA3 overlapping the lens 231, the amount of light that is totally reflected from the first side surface SS1 of the first light reflection portion 236_1 and emitted to the outside of the display device 290 may be very small.

Since the second light emitting area EA2 is not disposed to be adjacent to the black matrix 235, it is difficult for light emitted from the second light emitting area EA2 to be incident on the first side surface SS1 of the light reflection portion 236 at an angle of the critical angle or more. Therefore, a ratio of light totally reflected from the first side surface SS1 of the light reflection portion 236 among the light emitted from the second light emitting area EA2 may be lower than a ratio of light totally reflected from the first side surface SS1 of the light reflection portion 236 among the light emitted from the first light emitting area EA1 or the third light emitting area EA3.

The light emitting areas disposed to be adjacent to the black matrix 235 may be disposed at an edge of the lens 231, and the light emitting area that is not adjacent to the black matrix 235 and is disposed apart from the black matrix 235 may be disposed at the center of the lens 231. For example, as illustrated in FIG. 5, the first light emitting area EA1 and the third light emitting area EA3 disposed to be adjacent to the black matrix 235 may be disposed at the edge of the lens 231, and the second light emitting area EA2 may be disposed at the center of the lens 231.

The number of first light emitting areas EA1, the number of second light emitting areas EA2, and the number of third light emitting areas EA3 disposed to be adjacent to the black matrix 235 in the display device 290, may be substantially the same, and the number of first light emitting areas EA1, the number of second light emitting areas EA2, and the number of third light emitting areas EA3 that are not adjacent to the black matrix 235 and are disposed apart from the black matrix 235 in the display device 290 may be substantially the same. It is illustrated in FIG. 5 that for convenience of explanation, the first light emitting area EA1 and the third light emitting area EA3 are disposed to be adjacent to the black matrix 235, and the second light emitting area EA2 is not adjacent to the black matrix 235 and is disposed apart from the black matrix 235, but the embodiment of the present specification is not limited thereto. In another cross-section of the display device 290, the first light emitting area EA1 and the second light emitting area EA2 may be disposed to be adjacent to the black matrix 235, and the third light emitting area EA3 may not be adjacent to the black matrix 235 and may be disposed apart from the black matrix 235. Alternatively, in still another cross-section, the second light emitting area EA2 and the third light emitting area EA3 may be disposed to be adjacent to the black matrix 235, and the first light emitting area EA1 may not be adjacent to the black matrix 235 and may be disposed apart from the black matrix 235.

As illustrated in FIG. 5, the light emitted from the light emitting areas EA1, EA2, and EA3 and traveling toward the black matrix 235 may not be absorbed by the black matrix 235, but may be reflected by the light reflection portion 236 and emitted in the front direction of the display device 290. Accordingly, the luminance of the 2D image on the front surface of the display device 290 may be increased.

FIG. 6 is a cross-sectional view illustrating area A′ of FIG. 4.

Referring to FIG. 6, during the 3D image display period, the light reflection portion 236 may totally reflect light incident on the first side surface SS1 of the light reflection portion 236 at an angle of the critical angle or more. Since light emitted from the first light emitting area EA1 overlapping the lens 231 is incident on the first side surface SS1 of the first light reflection portion 236_1 adjacent to the first light emitting area EA1 at an angle of the critical angle or more, the light may be totally reflected on the first side surface SS1 of the first light reflection portion 236_1 and emitted in the front direction of the display device 290. For example, the first side surface SS1 of the first light reflection portion 236_1 may totally reflect light incident at an incident angle relative to a normal direction of the first side surface SS1 of the first light reflection portion 236_1 when the incident angle is equal to or greater than a critical angle for total reflectance according to the Snell's law. It is difficult for the light emitted from the first light emitting area EA1 overlapping the lens 231 to be incident on a first side surface SS1 of the second light reflection portion 236_2 disposed apart from the first light emitting area EA1 at the angle of the critical angle or more. For example, the light emitted from the first light emitting area EA1 may be incident on the first side surface SS1 of the second light reflection portion 236_2 at an incident angle less than a critical angle for total reflectance, and thus no total reflection occurs. Therefore, among the light emitted from the first light emitting area EA1 overlapping the lens 231, the amount of light that is totally reflected from the first side surface SS1 of the second light reflection portion 236_2 and emitted to the outside of the display device 290 may be very small.

Since light emitted from the third light emitting area EA3 overlapping the lens 231 is incident on the first side surface SS1 of the second light reflection portion 236_2 adjacent to the third light emitting area EA3 at an angle of the critical angle or more, the light may be totally reflected on the first side surface SS1 of the second light reflection portion 236_2 and emitted in the front direction of the display device 290. For example, the first side surface SS1 of the second light reflection portion 236_2 may totally reflect light incident from the third light emitting area EA3 at an incident angle relative to a normal direction of the first side surface SS1 of the second light reflection portion 236_2 when the incident angle is equal to or greater than a critical angle for total reflectance according to the Snell's law. It is difficult for the light emitted from the third light emitting area EA3 overlapping the lens 231 to be incident on a first side surface SS1 of the first light reflection portion 236_1 disposed apart from the third light emitting area EA3 at the angle of the critical angle or more. For example, the light emitted from the third light emitting area EA3 may be incident on the first side surface SS1 of the first light reflection portion 236_1 at an incident angle less than the critical angle for total reflectance, and thus no total reflection occurs. Therefore, among the light emitted from the third light emitting area EA3 overlapping the lens 231, the amount of light that is totally reflected from the first side surface SS1 of the first light reflection portion 236_1 and emitted to the outside of the display device 290 may be very small.

Since the second light emitting area EA2 is not disposed to be adjacent to the black matrix 235, it is difficult for light emitted from the second light emitting area EA2 to be incident on the first side surface SS1 of the light reflection portion 236 at an angle of the critical angle or more. Therefore, a ratio of light totally reflected from the first side surface SS1 of the light reflection portion 236 among the light emitted from the second light emitting area EA2 may be lower than a ratio of light totally reflected from the first side surface SS1 of the light reflection portion 236 among the light emitted from the first light emitting area EA1 or the third light emitting area EA3.

As illustrated in FIG. 6, the light emitted from the light emitting areas EA1, EA2, and EA3 and traveling toward the black matrix 235 may not be absorbed by the black matrix 235, but may be reflected by the light reflection portion 236 and emitted in the front direction of the display device 290. Accordingly, the luminance of the 3D image on the front surface of the display device 290 may be increased.

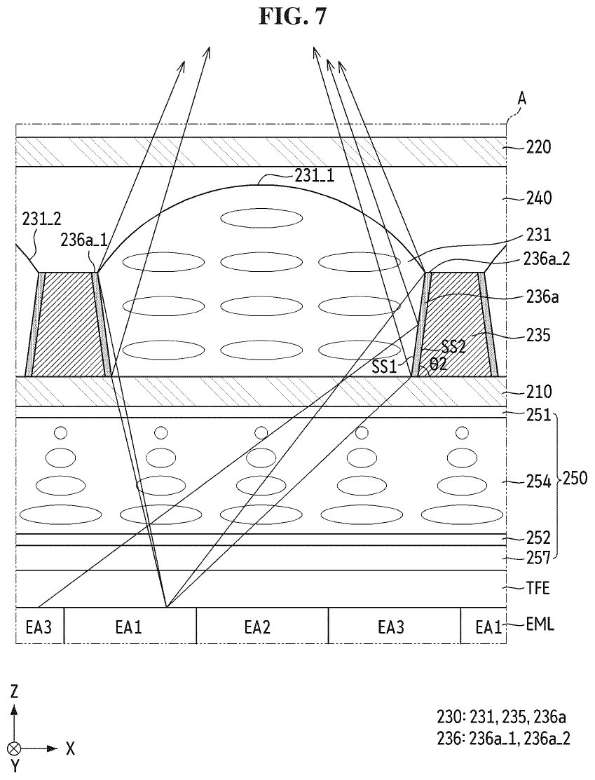

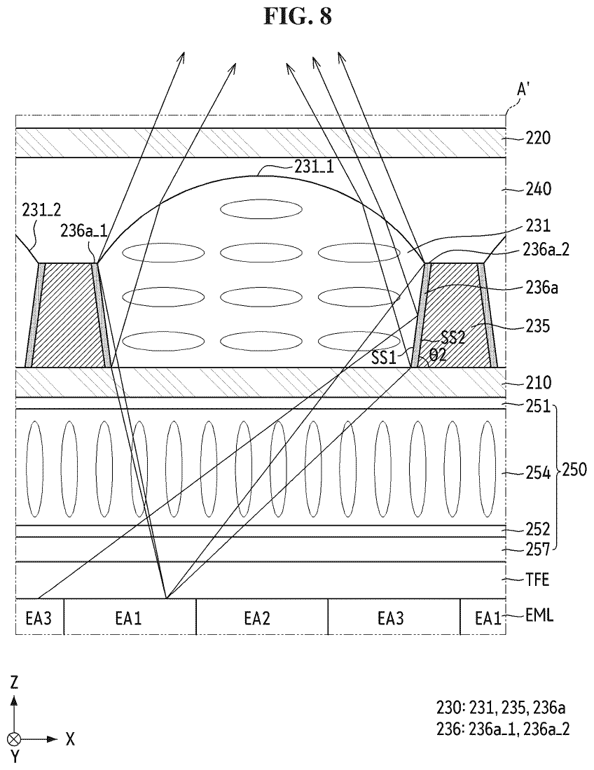

FIG. 7 is a cross-sectional view illustrating area A of FIG. 3. FIG. 8 is a cross-sectional view illustrating area A′ of FIG. 5.

FIGS. 7 and 8 illustrate an embodiment in which a light reflection portion 236a includes a metal that reflects light. FIG. 7 illustrates a 2D image display period, and FIG. 8 illustrates a 3D image display period. Any parts that overlap the contents described above will be omitted or briefly described, and the differences will be mainly described.

Referring to FIG. 7, the light reflection portion 236a may include a metal that reflects light. Accordingly, the light reflection portion 236a may reflect incident light without limitation on an incident angle of light.

For example, the light reflection portion 236a may reflect all light incident from the light emitting area regardless of whether the light emitting area is adjacent to the light reflection portion 236a. The light reflection portion 236a may reflect light emitted from a light emitting area adjacent to the light reflection portion 236a, as well as light emitted from a light emitting area distant from the light reflection portion 236a.

The light reflection units 236a in contact with a first lens 231_1 may include a first light reflection portion 236a_1 and a second light reflection portion 236a_2. The first light reflection portion 236a_1 may be disposed to be adjacent to the first light emitting area EA1 overlapping the first lens 231_1 compared to the second light reflection portion 236a_2. The second light reflection portion 236a_2 may be disposed to be adjacent to the third light emitting area EA3 overlapping the first lens 231_1 compared to the first light reflection portion 236a_1.

Light emitted from the first light emitting area EA1 overlapping the first lens 231_1 may be reflected from a first side surface SS1 of the first light reflection portion 236a_1 adjacent to the first light emitting area EA1 and emitted to the outside of the display device 290. The light emitted from the first light emitting area EA1 overlapping the first lens 231_1 may be reflected from a first side surface SS1 of the second light reflection portion 236a_2 disposed to be spaced apart from the first light emitting area EA1 and emitted to the outside of the display device 290.

Similarly, light emitted from the second light emitting area EA2 overlapping the first lens 231_1 may be reflected from the first side surface SS1 of the first light reflection portion 236a_1 in contact with the first lens 231_1 and emitted to the outside of the display device 290. The light emitted from the second light emitting area EA2 overlapping the first lens 231_1 may be reflected from the first side surface SS1 of the second light reflection portion 236a_2 disposed to be spaced apart from the second light emitting area EA2 and emitted to the outside of the display device 290.

Similarly, light emitted from the third light emitting area EA3 overlapping the first lens 231_1 may be reflected from the first side surface SS1 of the first light reflection portion 236a_1 in contact with the first lens 231_1 and emitted to the outside of the display device 290. The light emitted from the third light emitting area EA3 overlapping the first lens 231_1 may be reflected from a first side surface SS1 of the second light reflection portion 236a_2 disposed to be spaced apart from the third light emitting area EA3 and emitted to the outside of the display device 290.

Light emitted from the third light emitting area EA3 overlapping a second lens 231_2 adjacent to the first lens 231_1 may be reflected from the first side surface SS1 of the second light reflection portion 236a_2 in contact with the first lens 231_1 and emitted in the front direction of the display device 290. As a result, luminance on the front surface of the display device 290 may be further increased.

The first side surface SS1 of the light reflection portion 236a may be in contact with the first lens 231_1, and the second side surface SS2, which is an opposite surface of the first side surface SS1, may be in contact with the black matrix 235. The first side surface SS1 of the light reflection portion 236a may correspond to a side surface of the black matrix 235. A shape of the first side surface SS1 of the light reflection portion 236a may follow a shape of the side surface of the black matrix 235. When the shape of the side surface of the black matrix 235 has a flat plane shape, the shape of the first side surface SS1 of the light reflection portion 236a may also have a flat plane shape. An angle formed by the first side surface SS1 of the light reflection portion 236a and a lower surface of the black matrix 235 may be the same as an angle formed by the second side surface SS2 of the light reflection portion 236a and the lower surface of the black matrix 235. When viewed in a plan view, the light reflection portion 236a may be formed so that a length of the upper surface and a length of the lower surface are the same. For example, the upper surface of the light reflection portion 236a and the lower surface of the light reflection portion 236a may be the same in width measured in the X-axis direction.

For example, an angle θ2 formed by the second side surface SS2 of the light reflection portion 236a and the lower surface of the black matrix 235 may be 87° to 90°. However, the present embodiment is not limited to the above-mentioned angle, and the specific shapes of the black matrix 235 and the light reflection portion 236a may be modified so that an occurrence of crosstalk at a boundary of the plurality of lenses 231 may be minimized.

The first light emitting area EA1 will be described as an example. Light that has traveled from the first light emitting area EA1 to an upper side of the first light reflection portion 236a_1 may be reflected in a direction toward the center of the first lens 231_1. Light that has traveled from the first light emitting area EA1 to a lower side of the first light reflection portion 236a_1 may be reflected in a direction toward the center of the first lens 231_1.

Light that has traveled from the first light emitting area EA1 to an upper side of the second light reflection portion 236a_2 may be reflected in a direction toward the center of the first lens 231_1. Light that has traveled from the first light emitting area EA1 to a lower side of the second light reflection portion 236a_2 may be reflected in a direction toward the center of the first lens 231_1.

Although not illustrated in the drawings, light emitted from the second light emitting area EA2 and the third light emitting area EA3 may also be reflected from the first light reflection portion 236a_1 and the second light reflection portion 236a_2, directed toward the center of the first lens 231_1, and emitted to the outside of the display device 290. Therefore, the luminance of all light emitting areas EA1, EA2, and EA3 may be increased.

As illustrated in FIG. 7, since the light reflection portion 236a includes the metal that reflects light, all light incident on the first side surface SS1 of the light reflection portion 236a may be reflected. In particular, as the light reflected from the first side surface SS1 of the light reflection portion 236a is directed toward the center of the first lens 231_1 and is emitted to the outside of the display device 290, the luminance of the central portion of the first lens 231_1 may be increased.

Referring to FIG. 8, the light reflection portion 236a may reflect light emitted from the light emitting areas EA1, EA2, and EA3 during the 3D image display period and emit the light to the outside of the display device 290.

The first light emitting area EA1 overlapping the first lens 231_1 will be described as an example. Light that has traveled from the first light emitting area EA1 overlapping the first lens 231_1 to the upper side of the first light reflection portion 236a_1 may be reflected in a direction toward the center of the first lens 231_1. Light that has traveled from the first light emitting area EA1 overlapping the first lens 231_1 to the lower side of the first light reflection portion 236a_1 may be reflected in a direction toward the center of the first lens 231_1, and may be refracted in a direction toward the center of the first lens 231_1 at an interface between the first lens 231_1 and the filling layer 240.

Light that has traveled from the first light emitting area EA1 overlapping the first lens 231_1 to the upper side of the second light reflection portion 236a_2 may be reflected in a direction toward the center of the first lens 231_1. Light that has traveled from the first light emitting area EA1 overlapping the first lens 231_1 to the lower side of the second light reflection portion 236a_2 may be reflected in a direction toward the center of the first lens 231_1, and may be refracted in a direction toward the center of the first lens 231_1 at an interface between the first lens 231_1 and the filling layer 240.

Although not illustrated in the drawings, light emitted from the second light emitting area EA2 and the third light emitting area EA3 overlapping the first lens 231_1 may also be reflected from the first light reflection portion 236a_1 and the second light reflection portion 236a_2, directed toward the center of the first lens 231_1, and emitted to the outside of the display device 290. Therefore, the luminance of all light emitting areas EA1, EA2, and EA3 may be increased.

Light emitted from the third light emitting area EA3 overlapping a second lens 231_2 adjacent to the first lens 231_1 may be reflected from the first side surface SS1 of the second light reflection portion 236a_2 in contact with the first lens 231_1 and emitted in the front direction of the display device 290. As a result, luminance on the front surface of the display device 290 may be further increased.

As illustrated in FIG. 8, since the light reflection portion 236a includes the metal that reflects light, all light incident on the first side surface SS1 of the light reflection portion 236a may be reflected. In particular, as the light reflected from the first side surface SS1 of the light reflection portion 236a is directed toward the center of the first lens 231_1 and is emitted to the outside of the display device 290, the luminance of the central portion of the first lens 231_1 may be increased.

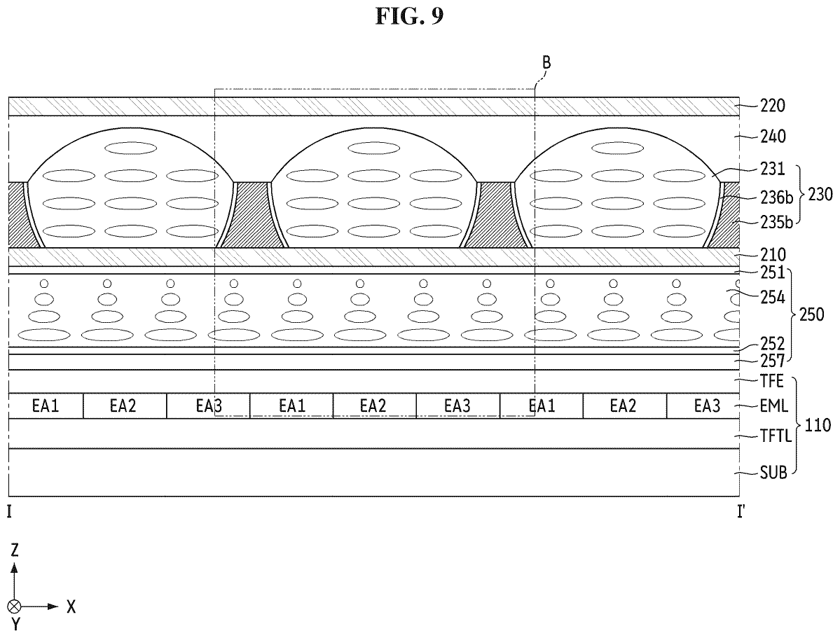

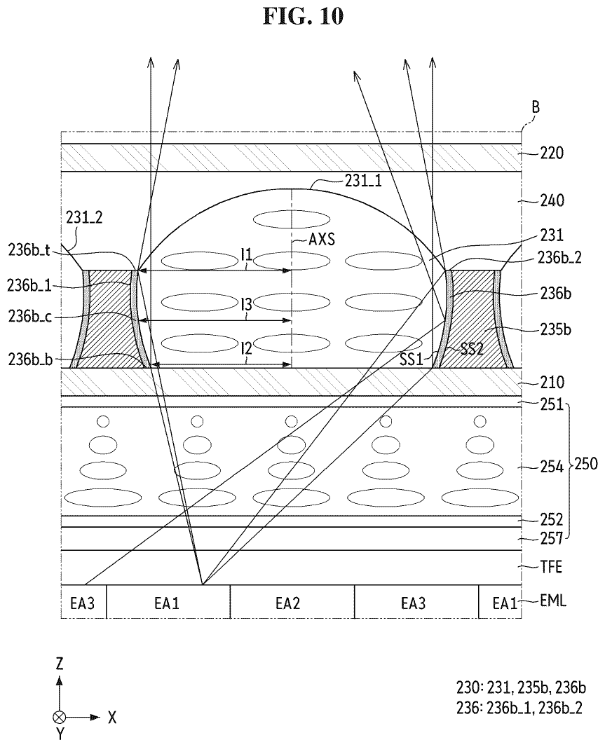

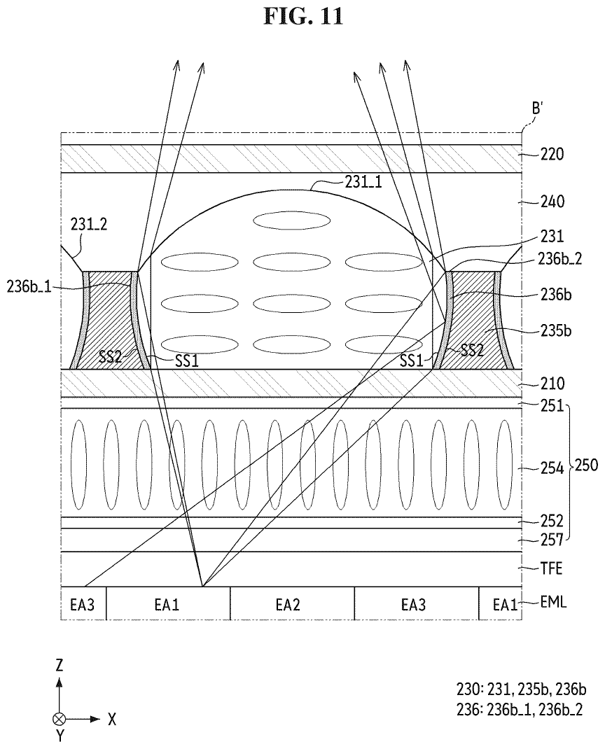

FIG. 9 is a cross-sectional view of the display device taken along line I-I′ of FIG. 2. FIGS. 10 and 11 are cross-sectional views illustrating area B of FIG. 9.

FIG. 10 illustrates a 2D image display period, and FIG. 11 illustrates a 3D image display period. Any parts that overlap the contents described above will be omitted or briefly described, and the differences will be mainly described.

Referring to FIG. 9, when viewed in a plan view, a length of an upper surface of a black matrix 235b may be shorter than a length of a lower surface of the black matrix 235b. For example, the upper surface of the black matrix 235b may be narrower than the lower surface of the black matrix 235b in width measured in the X-axis direction. A side surface of the black matrix 235b may be formed as a curved surface. For example, the side surface of the black matrix 235b may be concave.

A side surface of a light reflection portion 236b may correspond to the side surface of the black matrix 235b. A shape of the side surface of the light reflection portion 236b may follow a shape of the side surface of the black matrix 235b. The side surface of the light reflection portion 236b may be formed as a curved surface. In some embodiments, the side surface of the light reflection portion 236b may be concave.

The light reflection portion 236b may include a metal that reflects light. Accordingly, the light reflection portion 236b may reflect incident light without limitation on an incident angle of light.

Specifically, referring to FIG. 10, a first side surface SS1 of the light reflection portion 236b may be in contact with the plurality of lenses 231, and a second side surface SS2, which is an opposite surface of the first side surface SS1, may be in contact with the black matrix 235b. The first side surface SS1 of the light reflection portion 236b may correspond to a side surface of the black matrix 235b. A shape of the first side surface SS1 of the light reflection portion 236b may follow a shape of the side surface of the black matrix 235b. When the shape of the side surface of the black matrix 235b is a curved surface or a concave surface, the shape of the first side surface SS1 of the light reflection portion 236b may also be a curved surface or a concave surface.

The light reflection units 236b in contact with a first lens 231_1 may include a first light reflection portion 236b_1 and a second light reflection portion 236b_2. The first light reflection portion 236b_1 may be disposed to be adjacent to the first light emitting area EA1 overlapping the first lens 231_1 compared to the second light reflection portion 236b_2. The second light reflection portion 236b_2 may be disposed to be adjacent to the third light emitting area EA3 overlapping the first lens 231_1 compared to the first light reflection portion 236b_1.

The drawing illustrates an example in which one lens 231 overlaps one first light emitting area EA1, one second light emitting area EA2, and one third light emitting area EA3, but the present disclosure is not limited thereto. One lens 231 may overlap a plurality of light emitting areas EA1, EA2, and EA3, or may overlap different numbers of light emitting areas EA1, EA2, and EA3.

A distance l1 between an upper side 236b_t of the first light reflection portion 236b_1 and a central axis AXS of the first lens 231_1 in the first direction (X-axis direction) may be greater than a distance l3 between a central portion 236b_c of the first light reflection portion 236b_1 and the central axis AXS of the first lens 231_1.

The distance l3 between the central portion 236b_c of the first light reflection portion 236b_1 and the central axis AXS of the first lens 231_1 in the first direction (X-axis direction) may be greater than a distance l2 between a lower side 236b_b of the first light reflection portion 236b_1 and the central axis AXS of the first lens 231_1. The central portion 236b_c of the first light reflection portion 236b may be spaced apart from the upper side 236b_t and the lower side 236b_b of the first light reflection portion 236b by the same distance. For example, the central portion 236b_c may be disposed between the upper side 236b_t and the lower side 236b_b.

The amount of increase in the distance between a portion of the side surface of the first light reflection portion 236b_1 and the central axis AXS of the first lens 231_1 in the first direction (X-axis direction) may decrease from the lower side 236b_b to the upper side 236b_t of the first light reflection portion 236b_1. For example, a slope of the side surface of the first light reflection portion 236b_1 in the first direction (X-axis direction) may become steeper from the lower side 236b_b to the upper side 236b_t of the first light reflection portion 236b_1.

Similarly, the amount of increase in the distance between a portion of the side surface of the second light reflection portion 236b_2 and the central axis AXS of the first lens 231_1 in the first direction (X-axis direction) may decrease from a lower side to an upper side of the second light reflection portion 236b_2. For example, a slope of the side surface of the second light reflection portion 236b_2 in the first direction (X-axis direction) may become steeper from the lower side to the upper side of the second light reflection portion 236b_2. During the 2D image display period, the light reflection portion 236b may reflect light emitted from the light emitting areas EA1, EA2, and EA3 that overlap the first lens 231_1 that the first side surface SS1 of the light reflection portion 236b is in contact with. The light reflection portion 236b may reflect light emitted from a light emitting area overlapping a lens adjacent to the first lens 231_1.

For example, light emitted from the third light emitting area EA3 overlapping a second lens 231_2 adjacent to the first lens 231_1 may be reflected from the first side surface SS1 of the second light reflection portion 236b_2 in contact with the first lens 231_1 and emitted in the front direction of the display device 290. As a result, luminance on the front surface of the display device 290 may be further increased.

In other words, the light emitted from the light emitting areas EA1, EA2, and EA3 may be reflected from the light reflection portion 236b in contact with the lens 231 overlapping the light emitting areas EA1, EA2, and EA3 and emitted to the outside of the display device 290. The light emitted from the light emitting areas EA1, EA2, and EA3 may be reflected from the light reflection portion 236b adjacent to the lens 231 overlapping the light emitting areas EA1, EA2, and EA3 and emitted to the outside of the display device 290.

Light that has traveled from the first light emitting area EA1 overlapping the first lens 231_1 to an upper side 236b_t of the first light reflection portion 236b_1 may be reflected in a direction toward the edge of the first lens 231_1. Light that has traveled from the first light emitting area EA1 overlapping the first lens 231_1 to a lower side 236b_b of first light reflection portion 236b_1 may be reflected in a direction toward the edge of the first lens 231_1.

Light that has traveled from the first light emitting area EA1 overlapping the first lens 231_1 to an upper side of the second light reflection portion 236b_2 may be reflected in a direction toward the edge of the first lens 231_1. Light that has traveled from the first light emitting area EA1 overlapping the first lens 231_1 to a lower side of the second light reflection portion 236b_2 may be reflected in a direction toward the edge of the first lens 231_1.

Although not illustrated in the drawings, light emitted from the second light emitting area EA2 and the third light emitting area EA3 overlapping the first lens 231_1 may also be reflected from the first light reflection portion 236b_1 and the second light reflection portion 236b_2, directed toward the edge of the first lens 231_1, and emitted to the outside of the display device 290. Therefore, the luminance of all light emitting areas EA1, EA2, and EA3 may be increased.

As illustrated in FIG. 10, since the light reflection portion 236b includes the metal that reflects light, all light incident on the first side surface SS1 of the light reflection portion 236b may be reflected. In particular, as the light reflection portion 236b is formed as a concave surface, the light reflected from the first side surface SS1 of the light reflection portion 236b is directed toward edges of the first lens 231_1 and the lens adjacent to the first lens 231_1 and is emitted to the outside of the display device 290, so that luminance at the edges of the first lens 231_1 and the lens adjacent to the first lens 231_1 may be increased.

Referring to FIG. 11, the light reflection portion 236b may reflect the light emitted from the light emitting areas EA1, EA2, and EA3 during the 3D image display period and emit the light to the outside of the display device 290.

The first light emitting area EA1 overlapping the first lens 231_1 will be described as an example. Light that has traveled from the first light emitting area EA1 overlapping the first lens 231_1 to an upper side of the first light reflection portion 236b_1 may be reflected in a direction toward the edge of the first lens 231_1. Light that has traveled from the first light emitting area EA1 overlapping the first lens 231_1 to a lower side of the first light reflection portion 236b_1 may be reflected in a direction toward the edge of the first lens 231_1, and may be refracted in a direction toward the center of the first lens 231_1 at an interface between the first lens 231_1 and the filling layer 240.

Light that has traveled from the first light emitting area EA1 overlapping the first lens 231_1 to an upper side of the second light reflection portion 236b_2 may be reflected in a direction toward the edge of the first lens 231_1. Light that has traveled from the first light emitting area EA1 overlapping the first lens 231_1 to a lower side of the second light reflection portion 236b_2 may be reflected in a direction toward the edge of the first lens 231_1, and may be refracted in a direction toward the center of the first lens 231_1 at an interface between the first lens 231_1 and the filling layer 240.

Although not illustrated in the drawings, light emitted from the second light emitting area EA2 and the third light emitting area EA3 overlapping the first lens 231_1 may also be reflected from the first light reflection portion 236b_1 and the second light reflection portion 236b_2, directed toward the edge or the center of the first lens 231_1, and emitted to the outside of the display device 290. Therefore, the luminance of all light emitting areas EA1, EA2, and EA3 may be increased.

Light emitted from the third light emitting area EA3 overlapping a second lens 231_2 adjacent to the first lens 231_1 may be reflected from the first side surface SS1 of the second light reflection portion 236a_2 in contact with the first lens 231_1 and emitted in the front direction of the display device 290. As a result, luminance on the front surface of the display device 290 may be further increased.

As illustrated in FIG. 11, since the light reflection portion 236b includes the metal that reflects light, all light incident on the first side surface SS1 of the light reflection portion 236b may be reflected. In particular, as the light reflected from the first side surface SS1 of the light reflection portion 236b is directed toward the edge or the center of the first lens 231_1 and is emitted to the outside of the display device 290, the luminance of the edge or the center portion of the first lens 231_1 may be increased.

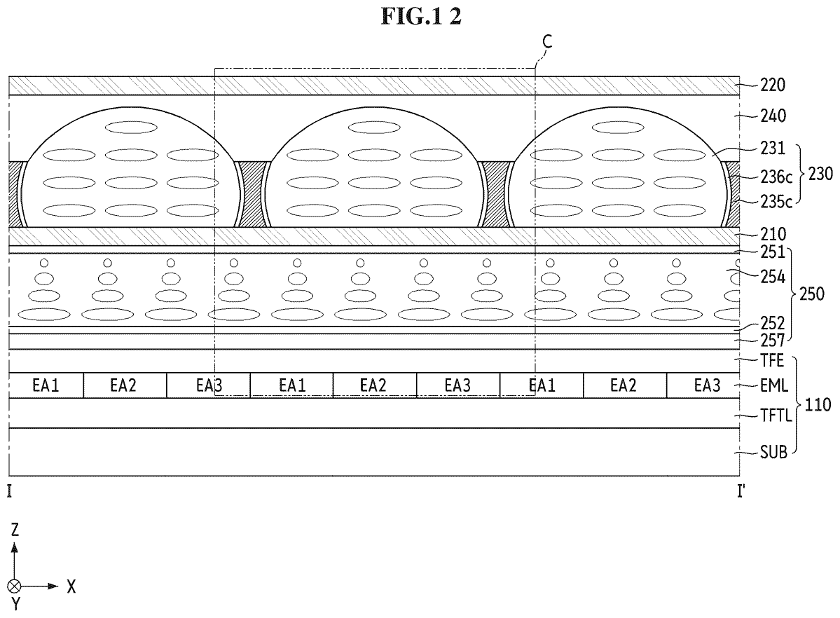

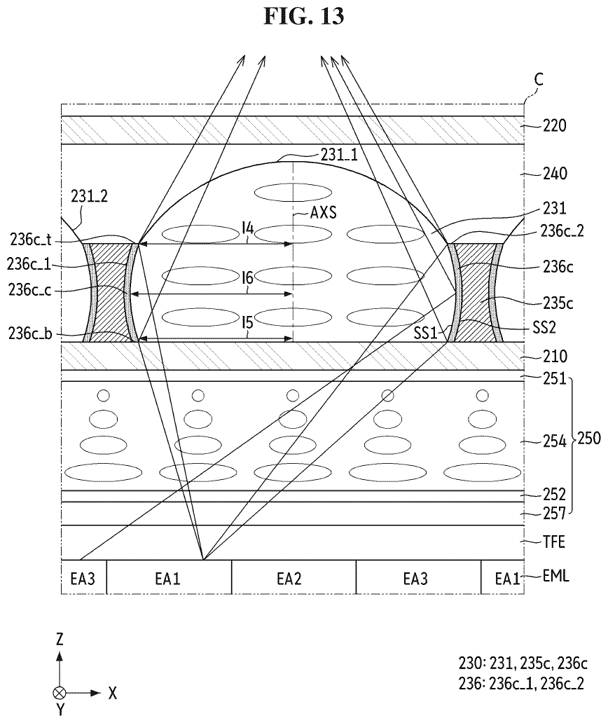

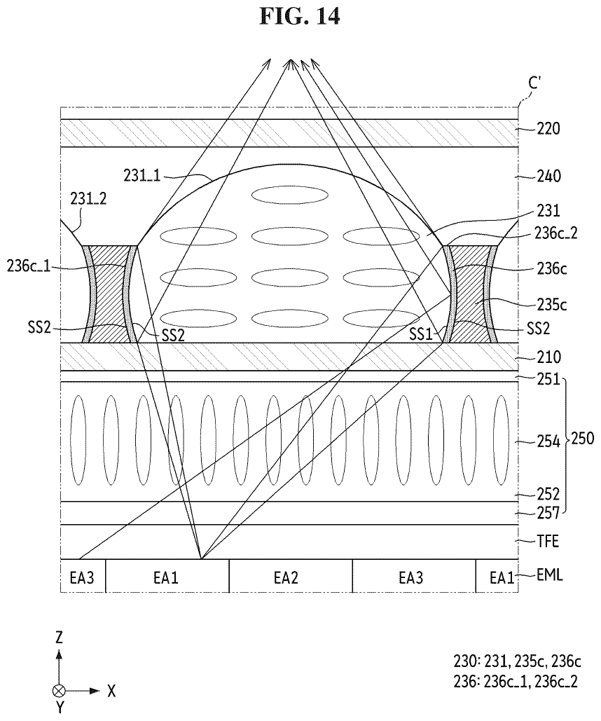

FIG. 12 is a cross-sectional view of the display device taken along line I-I′ of FIG. 2. FIGS. 13 and 14 are cross-sectional views illustrating area C of FIG. 12.

FIG. 13 illustrates a 2D image display period, and FIG. 14 illustrates a 3D image display period. Any parts that overlap the contents described above will be omitted or briefly described, and the differences will be mainly described.

Referring to FIG. 12, when viewed in a plan view, a length of an upper surface of a black matrix 235c may be equal to a length of a lower surface of the black matrix 235c. A side surface of the black matrix 235c may be formed as a curved surface. In some embodiments, the side surface of the black matrix 235c may be concave.

A side surface of a light reflection portion 236c may correspond to the side surface of the black matrix 235c. A shape of the side surface of the light reflection portion 236c may follow a shape of the side surface of the black matrix 235c. The side surface of the light reflection portion 236c may be formed as a curved surface. In some embodiments, the side surface of the light reflection portion 236c may be concave.

The light reflection portion 236c may include a metal that reflects light. Accordingly, the light reflection portion 236c may reflect incident light without limitation on an incident angle of light.

Specifically, referring to FIG. 13, a first side surface SS1 of the light reflection portion 236c may be in contact with the plurality of lenses 231, and a second side surface SS2, which is an opposite surface of the first side surface SS1, may be in contact with the black matrix 235c. The first side surface SS1 of the light reflection portion 236c may correspond to a side surface of the black matrix 235c. A shape of the first side surface SS1 of the light reflection portion 236c may follow a shape of the side surface of the black matrix 235c. When the shape of the side surface of the black matrix 235c is a curved surface or a concave surface, the shape of the first side surface SS1 of the light reflection portion 236c may also be a curved surface or a concave surface.

The light reflection units 236c in contact with the first lens 231_1 may include a first light reflection portion 236c_1 and a second light reflection portion 236c_2. The first light reflection portion 236c_1 may be disposed to be adjacent to the first light emitting area EA1 overlapping the first lens 231_1 compared to the second light reflection portion 236c_2. The second light reflection portion 236c_2 may be disposed to be adjacent to the third light emitting area EA3 overlapping the first lens 231_1 compared to the first light reflection portion 236c_1.

The drawing illustrates an example in which one lens 231 overlaps one first light emitting area EA1, one second light emitting area EA2, and one third light emitting area EA3, but the present disclosure is not limited thereto. One lens 231 may overlap a plurality of light emitting areas EA1, EA2, and EA3, or may overlap different numbers of light emitting areas EA1, EA2, and EA3.

A distance l4 between an upper side 236c_t of the first light reflection portion 236c_1 and a central axis AXS of the first lens 231_1 in the first direction (X-axis direction) may be shorter than a distance l6 between a central portion 236c_c of the first light reflection portion 236c_1 and the central axis AXS of the first lens 231_1.

The distance l6 between the central portion 236c_c of the first light reflection portion 236c_1 and the central axis AXS of the first lens 231_1 in the first direction (X-axis direction) may be greater than a distance l5 between a lower side 236c_b of the first light reflection portion 236c_1 and the central axis AXS of the first lens 231_1. The central portion 236c_c of the first light reflection portion 236c_1 may be spaced apart from the upper side 236c_t and the lower side 236c_b of the first light reflection portion 236c_1 by the same distance.

The amount of increase in the distance between a portion of the side surface of the first light reflection portion 236c_1 and the central axis AXS of the first lens 231_1 in the first direction (X-axis direction) may decrease from the lower side 236c_b to the central portion 236c_c of the first light reflection portion 236c_1 and may then increase from the central portion 236c_c to the upper side 236c_t of the first light reflection portion 236c_1. For example, a size of a slope of the side surface of the first light reflection portion 236c_1 in the first direction (X-axis direction) may increase from the lower side 236c_b to the central portion 236c_c of the first light reflection portion 236c_1, and may then decrease from the central portion 236c_c to the upper side 236c_t of the first light reflection portion 236c_1.

Similarly, the amount of increase in the distance between a portion of the side surface of the second light reflection portion 236c_2 and the central axis AXS of the first lens 231_1 in the first direction (X-axis direction) may decrease from a lower side to a central portion of the second light reflection portion 236c_2, and may then increase from the central portion to the upper side of the second light reflection portion 236c_2. For example, a size of a slope of the side surface of the second light reflection portion 236c_2 in the first direction (X axis direction) may increase from the lower side to the central portion of the second light reflection portion 236c_2, and may then decrease from the central portion to the upper side of the second light reflection portion 236c_2.

During the 2D image display period, the light reflection portion 236c may reflect light emitted from the light emitting areas EA1, EA2, and EA3 that overlap the first lens 231_1 that the first side surface SS1 of the light reflection portion 236c is in contact with. The light reflection portion 236c may reflect light emitted from a light emitting area overlapping a lens adjacent to the first lens 231_1.

For example, light emitted from the third light emitting area EA3 overlapping a second lens 231_2 adjacent to the first lens 231_1 may be reflected from the first side surface SS1 of the second light reflection portion 236b_2 in contact with the first lens 231_1 and emitted in the front direction of the display device 290. As a result, luminance on the front surface of the display device 290 may be further increased.

The light emitted from the light emitting areas EA1, EA2, and EA3 may be reflected from the light reflection portion 236c in contact with the lens 231 overlapping the light emitting areas EA1, EA2, and EA3 and emitted to the outside of the display device 290. The light emitted from the light emitting areas EA1, EA2, and EA3 may be reflected from the light reflection portion 236c in contact with the lens 231 adjacent to the lens 231 overlapping the light emitting areas EA1, EA2, and EA3 and emitted to the outside of the display device 290.

Light that has traveled from the first light emitting area EA1 overlapping the first lens 231_1 to an upper side 236c_t of the first light reflection portion 236c_1 may be reflected to a specific position. Light that has traveled from the first light emitting area EA1 overlapping the first lens 231_1 to a lower side 236c_b of the first light reflection portion 236c_1 may be reflected to the specific position.

Light that has traveled from the first light emitting area EA1 overlapping the first lens 231_1 to an upper side of the second light reflection portion 236c_2 may be reflected to the specific position. Light that has traveled from the first light emitting area EA1 overlapping the first lens 231_1 to a lower side of the second light reflection portion 236c_2 may be reflected to the specific position.

The specific position may be determined by at least one of a curvature of the light reflection portion 236c, a height of the light reflection portion 236c, a curvature of the plurality of lenses 231, a refractive index of the plurality of lenses 231, and a distance between the light emitting areas EA1, EA2, and EA3 and the plurality of lenses 231.

Although not illustrated in the drawings, light emitted from the second light emitting area EA2 and the third light emitting area EA3 overlapping the first lens 231_1 may also be reflected from the first light reflection portion 236c_1 and the second light reflection portion 236c_2, directed toward the center of the first lens 231_1, and emitted to the outside of the display device 290. Therefore, the luminance of all light emitting areas EA1, EA2, and EA3 may be increased.

As illustrated in FIG. 13, since the light reflection portion 236c includes the metal that reflects light, all light incident on the first side surface SS1 of the light reflection portion 236c may be reflected. In particular, as the light reflection portion 236c is has a concave surface and the lengths of the upper and lower sides of the light reflection portion 236c in the first direction (X-axis direction) are the same, the light reflected from the first side surface SS1 of the light reflection portion 236c is directed toward a specific position and is emitted to the outside of the display device 290, so that when the display device 290 is observed from the specific position, the luminance of the display device 290 may be increased.

Referring to FIG. 14, the light reflection portion 236c may reflect the light emitted from the light emitting areas EA1, EA2, and EA3 during the 3D image display period and emit the light to the outside of the display device 290.

The first light emitting area EA1 overlapping the first lens 231_1 will be described as an example. Light that has traveled from the first light emitting area EA1 overlapping the first lens 231_1 to an upper side 236c_t of the first light reflection portion 236c_1 may be reflected to the specific position. Light that has traveled from the first light emitting area EA1 overlapping the first lens 231_1 to a lower side 236c_b of the first light reflection portion 236c_1 may be reflected in a direction toward the specific position, and may be refracted in a direction toward the center of the first lens 231_1 at an interface between the first lens 231_1 and the filling layer 240.

Light that has traveled from the first light emitting area EA1 overlapping the first lens 231_1 to an upper side of the second light reflection portion 236c_2 may be reflected to the specific position. Light that has traveled from the first light emitting area EA1 overlapping the first lens 231_1 to a lower side of the second light reflection portion 236c_2 may be reflected in a direction toward the specific position, and may be refracted in a direction toward the center of the first lens 231_1 at an interface between the first lens 231_1 and the filling layer 240.

The specific position may be determined by at least one of a curvature of the light reflection portion 236c, a height of the light reflection portion 236c, a curvature of the plurality of lenses 231, a refractive index of the plurality of lenses 231, and a distance between the light emitting areas EA1, EA2, and EA3 and the plurality of lenses 231.

Although not illustrated in the drawings, light emitted from the second light emitting area EA2 and the third light emitting area EA3 overlapping the first lens 231_1 may also be reflected from the first light reflection portion 236c_1 and the second light reflection portion 236c_2, directed toward the center of the first lens 231_1, and emitted to the outside of the display device 290. Therefore, the luminance of all light emitting areas EA1, EA2, and EA3 may be increased.

Light emitted from the third light emitting area EA3 overlapping a second lens 231_2 adjacent to the first lens 231_1 may be reflected from the first side surface SS1 of the second light reflection portion 236c_2 in contact with the first lens 231_1 and emitted in the front direction of the display device 290. As a result, luminance on the front surface of the display device 290 may be further increased.

As illustrated in FIG. 14, since the light reflection portion 236c includes the metal that reflects light, all light incident on the first side surface SS1 of the light reflection portion 236c may be reflected. In particular, as the light reflection portion 236c has a concave surface and the lengths of the upper and lower sides of the light reflection portion 236c in the first direction (X-axis direction) are the same, the light reflected from the first side surface SS1 of the light reflection portion 236c is directed toward a specific position and is emitted to the outside of the display device 290, so that when the display device 290 is observed from the specific position, the luminance of the display device 290 may be increased.

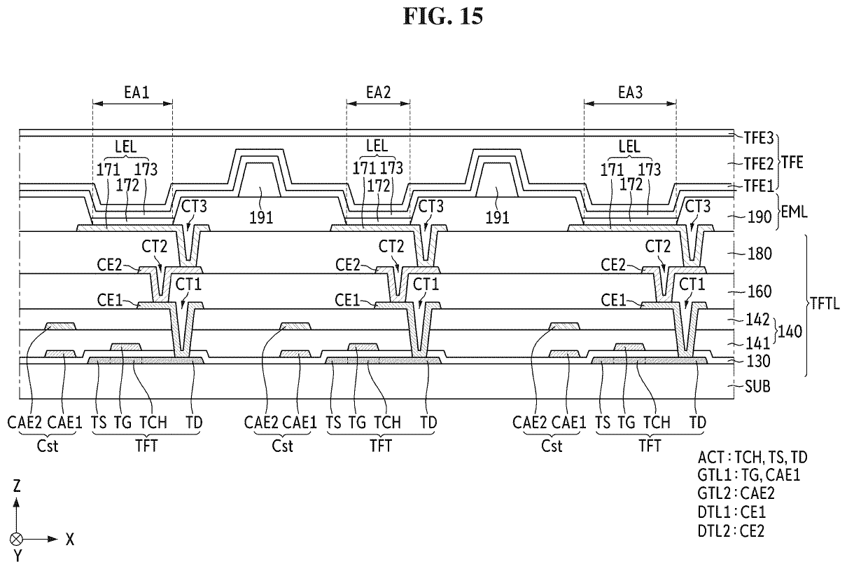

FIG. 15 is a cross-sectional view illustrating a substrate, a thin film transistor layer, a light emitting element layer, and an encapsulation film of FIG. 3.

Referring to FIG. 15, the display panel 110 may include a substrate SUB, a thin film transistor layer TFTL, a light emitting element layer EML, and an encapsulation layer TFE.

The thin film transistor layer TFTL includes an active layer ACT, a first gate layer GTL1, a second gate layer GTL2, a first data metal layer DTL1, and a second data metal layer DTL2. The thin film transistor layer TFTL includes a gate insulating film 130, a first interlayer insulating film 141, a second interlayer insulating film 142, a first planarization film 160, and a second planarization film 180. The thin film transistor layer TFTL includes a plurality of thin film transistors TFT, each of which includes a channel TCH, a gate electrode TG, a first electrode TS, and a second electrode TD.

The active layer ACT may be disposed on the substrate SUB. The active layer ACT may include a silicon semiconductor such as polycrystalline silicon, single crystal silicon, and low-temperature polycrystalline silicon, or may include an oxide semiconductor.

The active layer ACT may include the channel TCH, the first electrode TS, and the second electrode TD of each of the plurality of thin film transistors TFT. The channel TCH may be an area overlapping the gate electrode TG of the thin film transistor TFT in the third direction (Z-axis direction) that is a thickness direction of the substrate SUB. The first electrode TS may be disposed on one side of the channel TCH, and the second electrode TD may be disposed on the other side of the channel TCH. The first electrode TS and the second electrode TD may be areas that do not overlap the gate electrode TG in the third direction(Z-axis direction). The first electrode TS and the second electrode TD may be areas in which ions are doped into a silicon semiconductor or an oxide semiconductor to provide conductivity.

The gate insulating film 130 may be disposed on the active layer ACT. The gate insulating film 130 may be formed as an inorganic film, for example, a silicon nitride layer, a silicon oxynitride layer, a silicon oxide layer, a titanium oxide layer, or an aluminum oxide layer.

The first gate layer GTL1 may be disposed on the gate insulating film 130. The first gate layer GTL1 may include a gate electrode TG and a first capacitor electrode CAE1 of each of the plurality of thin film transistors TFT. The first gate layer GTL1 may be formed as a single layer or a multi-layer made of any one of molybdenum (Mo), aluminum (Al), chromium (Cr), gold (Au), titanium (Ti), nickel (Ni), neodymium (Nd), and copper (Cu), or an alloy thereof.

The first interlayer insulating film 141 may be disposed on the first gate layer GTL1. The first interlayer insulating film 141 may be formed as an inorganic film, for example, a silicon nitride layer, a silicon oxynitride layer, a silicon oxide layer, a titanium oxide layer, or an aluminum oxide layer.

The second gate layer GTL2 may be disposed on the first interlayer insulating film 141. The second gate layer GTL2 may include a second capacitor electrode CAE2. The second capacitor electrode CAE2 may overlap the first capacitor electrode CAE1 in the third direction (Z-axis direction). The capacitor Cst may include the first capacitor electrode CAE1 and the second capacitor electrode CAE2. The second gate layer GTL2 may be formed as a single layer or a multi-layer made of any one of molybdenum (Mo), aluminum (Al), chromium (Cr), gold (Au), titanium (Ti), nickel (Ni), neodymium (Nd), and copper (Cu), or an alloy thereof.

The second interlayer insulating film 142 may be disposed on the second gate layer GTL2. The second interlayer insulating film 142 may be formed as an inorganic film, for example, a silicon nitride layer, a silicon oxynitride layer, a silicon oxide layer, a titanium oxide layer, or an aluminum oxide layer.

A first data metal layer DTL1 including a first connection electrode CE1 may be disposed on the second interlayer insulating film 142. The first connection electrode CE1 may be connected to the first electrode TS or the second electrode TD of the thin film transistor TFT through a first contact hole CT1 penetrating through the gate insulating film 130, the first interlayer insulating film 141 and the second interlayer insulating film 142. The first data metal layer DTL1 may be formed as a single layer or a multi-layer made of any one of molybdenum (Mo), aluminum (Al), chromium (Cr), gold (Au), titanium (Ti), nickel (Ni), neodymium (Nd), and copper (Cu), or an alloy thereof.

A first planarization film 160 for planarizing a step caused by the active layer ACT, the first gate layer GTL1, the second gate layer GTL2, and the first data metal layer DTL1 may be disposed on the first data metal layer DTL1. The first planarization film 160 may be formed as an organic film made of an acryl resin, an epoxy resin, a phenolic resin, a polyamide resin, a polyimide resin, or the like.

The second data metal layer DTL2 may be disposed on the first planarization film 160. The second data metal layer DTL2 may include a second connection electrode CE2. The second connection electrode CE2 may be connected to the first connection electrode CE1 through a second contact hole CT2 penetrating through the first planarization film 160. The second data metal layer DTL2 may be formed as a single layer or a multi-layer made of any one of molybdenum (Mo), aluminum (Al), chromium (Cr), gold (Au), titanium (Ti), nickel (Ni), neodymium (Nd), and copper (Cu), or an alloy thereof.

The second planarization film 180 may be disposed on the second data metal layer DTL2. The second planarization film 180 may be formed as an organic film made of an acryl resin, an epoxy resin, a phenolic resin, a polyamide resin, a polyimide resin, or the like.

A light emitting element layer EML may be disposed on the second planarization film 180. The light emitting element layer EML may include a plurality of light emitting elements LEL and a pixel defining film 190. Each of the plurality of light emitting elements LEL may be an organic light emitting diode element including a pixel electrode 171, a light emitting layer 172, and a common electrode 173, but the embodiments of the present specification are not limited thereto.

The pixel electrode 171 may be disposed on the second planarization film 180. The pixel electrode 171 may be connected to the second connection electrode CE2 through a third contact hole CT3 penetrating through the second planarization film 180.

In a top emission structure that emits light in a direction of the common electrode 173 with respect to the light emitting layer 172, the pixel electrode 171 may be formed of a metal material having high reflectance, such as a stacked structure (Ti/Al/Ti) of aluminum and titanium, a stacked structure (ITO/Al/ITO) of aluminum and indium tin oxide (ITO), an APC alloy, and a stacked structure (ITO/APC/ITO) of an APC alloy and ITO. The APC alloy is an alloy of silver (Ag), palladium (Pd), and copper (Cu).

The pixel defining film 190 may be disposed on the second planarization film 180 to cover an edge of each of the pixel electrodes 171 to define a plurality of light emitting units EA. The pixel defining film 190 may be formed as an organic film made of an acryl resin, an epoxy resin, a phenolic resin, a polyamide resin, or a polyimide resin.

Each of the light emitting units EA represents an area in which the pixel electrode 171, the light emitting layer 172, and the common electrode 173 are sequentially stacked, and holes from the pixel electrode 171 and electrons from the common electrode 173 are re-bonded with each other in the light emitting layer 172 to emit light.

The light emitting layer 172 may be disposed on the pixel electrode 171. The light emitting layer 172 may include an organic material to emit light of a predetermined color. For example, the light emitting layer 172 may include a hole transporting layer, an organic material layer, and an electron transporting layer.

The common electrode 173 may be disposed on the light emitting layer 172. The common electrode 173 may be disposed to cover the light emitting layer 172. The common electrode 173 may be a common layer commonly formed in the plurality of light emitting units EA. A capping layer may be formed on the common electrode 173.

In the top emission structure, the common electrode 173 may be formed of a transparent conductive material (TCO) such as ITO and indium zinc oxide (IZO) capable of transmitting light, or a semi-transmissive conductive material such as magnesium (Mg), silver (Ag), and an alloy of magnesium (Mg) and silver (Ag). When the common electrode 173 is formed of the semi-transmissive conductive material, light emitting efficiency may be increased by a micro cavity.

A spacer 191 may be disposed on the pixel defining film 190. The spacer 191 may serve to support a mask during a process of manufacturing the light emitting layer 172. The spacer 191 may be formed as an organic film made of an acryl resin, an epoxy resin, a phenolic resin, a polyamide resin, a polyimide resin, or the like.

An encapsulation layer TFE may be disposed on the common electrode 173. The encapsulation layer TFE may include at least one inorganic film to prevent oxygen or moisture from permeating into the light emitting element layer EML. The encapsulation layer TFE may include at least one organic film to protect the light emitting element layer EML from foreign materials such as dust. For example, the encapsulation layer TFE may include a first encapsulation inorganic film TFE1, an encapsulation organic film TFE2, and a second encapsulation inorganic film TFE3.

The first encapsulation inorganic film TFE1 may be disposed on the common electrode 173, the encapsulation organic film TFE2 may be disposed on the first encapsulation inorganic film TFE1, and the second encapsulation inorganic film TFE3 may be disposed on the encapsulation organic film TFE2. The first encapsulation inorganic film TFE1 and the second encapsulation inorganic film TFE3 may be formed as a multi-film in which one or more inorganic films of a silicon nitride layer, a silicon oxynitride layer, a silicon oxide layer, a titanium oxide layer, and an aluminum oxide layer are alternately stacked. The encapsulation organic film TFE2 may be an organic film made of an acrylic resin, an epoxy resin, a phenolic resin, a polyamide resin, or a polyimide resin.

For example, it is illustrated in FIG. 15 that the third light emitting area EA3 is greater than the first light emitting area EA1, and the first light emitting area EA1 is greater than the second light emitting area EA2. Here, the first light emitting area EA1 may be a red light emitting area, the second light emitting area EA2 may be a green light emitting area, and the third light emitting area EA3 may be a blue light emitting area. However, the present embodiment is not limited to the relative sizes of the light emitting areas.

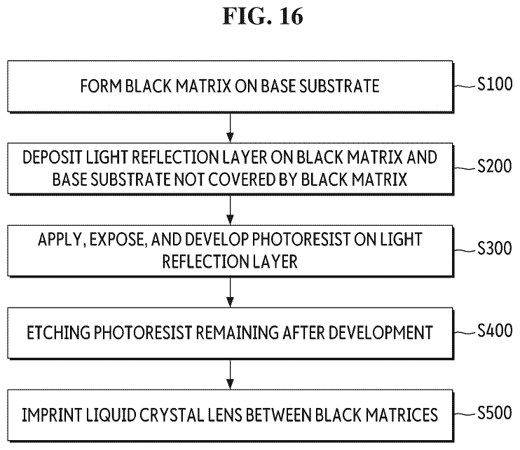

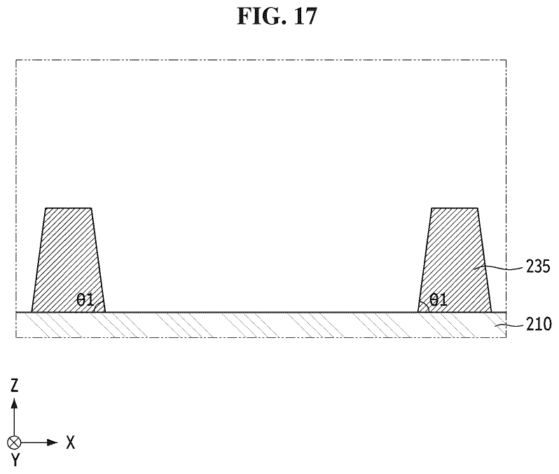

FIG. 16 is a flowchart for describing a manufacturing method of a display device according to some embodiments of the present disclosure. FIGS. 17 to 23 are views for describing a manufacturing method of a display device according to some embodiments of the present disclosure.

Hereinafter, a manufacturing method of a display device according to some embodiments of the present disclosure will be described with reference to FIGS. 16 to 23. Any parts that overlap the embodiments described above will be omitted or briefly described.

First, a black matrix 235 is formed on a first base substrate 210 (S100 in FIG. 16).

Specifically, referring to FIG. 17, a black matrix 235 is formed on a first base substrate 210. In the first direction (X-axis direction), a length of a lower surface of the black matrix 235 may be longer than a length of an upper surface of the black matrix 235. For example, an angle θ1 formed by a side surface of the black matrix 235 and the lower surface of the black matrix 235 may be 87° to 90°.

Next, a light reflection portion 236 is deposited on the black matrix 235 and the first base substrate 210 not covered by the black matrix 235 (S200 in FIG. 16).

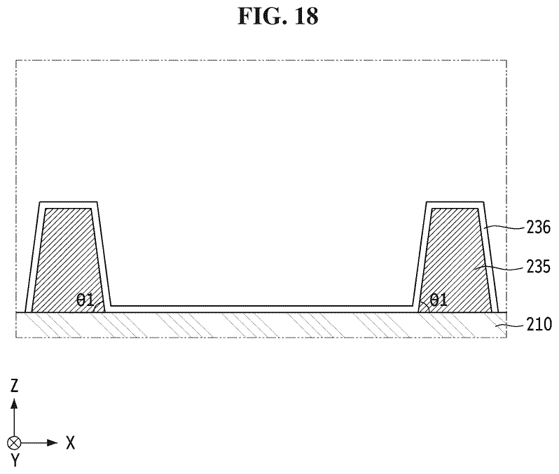

Referring to FIG. 18, the light reflection portion 236 may be deposited on the black matrix 235 and the first base substrate 210 that is exposed without being covered by the black matrix 235. In an area overlapping the black matrix 235, the light reflection portion 236 may follow the shape of the black matrix 235.

Next, a photoresist PR is applied, exposed, and developed on the light reflection portion 236 (S300 in FIG. 16).

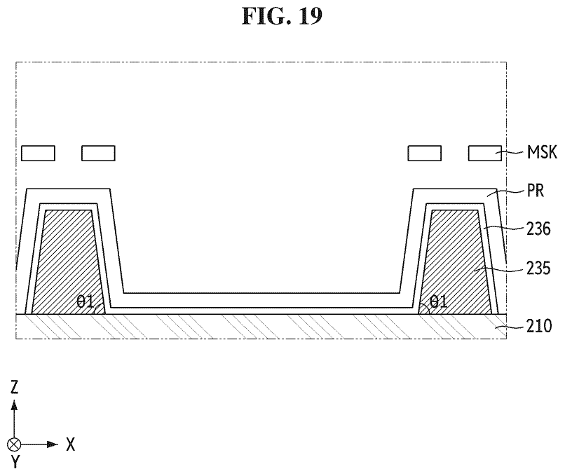

Referring to FIG. 19, a photoresist PR may be applied on the light reflection portion 236. In an area overlapping the black matrix 235, the photoresist PR may follow the shape of the black matrix 235.

Exposure may be performed on the photoresist PR using a mask MSK having an opening formed therein. The opening of the mask MSK may overlap the black matrix 235 in the third direction (Z-axis direction).

Next, the photoresist PR remaining after development is etched (S400 in FIG. 16).

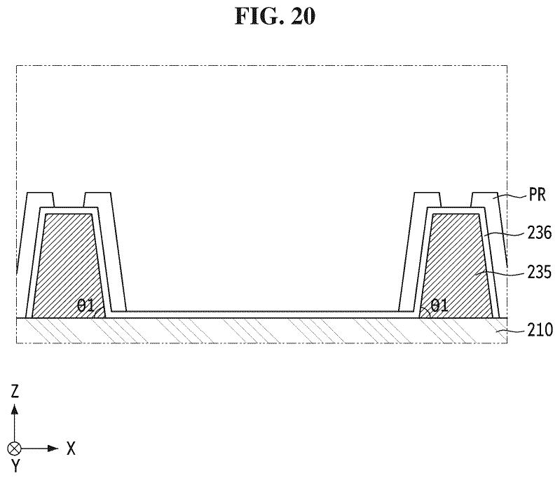

Referring to FIG. 20, the photoresist PR remaining after development is etched using a wet etch or a dry etch. In such a process, a portion of the light reflection portion 236 that is exposed without being covered by the photoresist PR may be removed.

Next, a liquid crystal lens is imprinted between the black matrices 235 (S500 in FIG. 16).

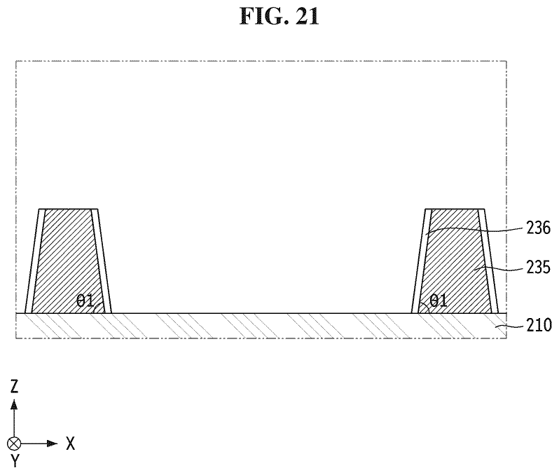

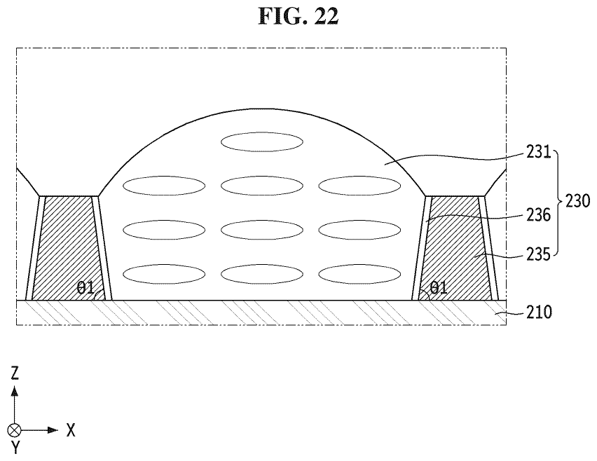

Referring to FIG. 21, after etching, the light reflection portion 236 may remain only on the side surface of the black matrix 235. Referring to FIG. 22, a plurality of lenses 231 may be imprinted between the light reflection units 236 of the black matrix 235.

Next, a second base substrate 220 and a filling layer 240 may be disposed on the plurality of lenses 231, the black matrix 235, and the light reflection portion 236.

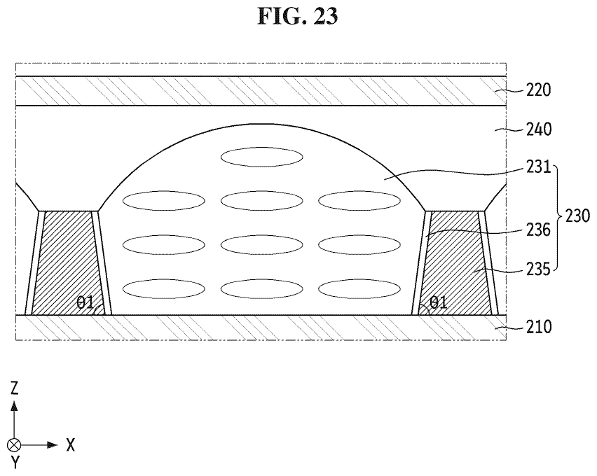

Referring to FIG. 23, the filling layer 240 may have a refractive index in a short axis direction of the liquid crystal included in the plurality of lenses 231 Accordingly, depending on a polarization direction of light passing through the plurality of lenses 231, refraction may or may not occur at an interface between the plurality of lenses 231 and the filling layer 240.

The second base substrate 220 may include a material such as glass and plastic through which the light may pass.

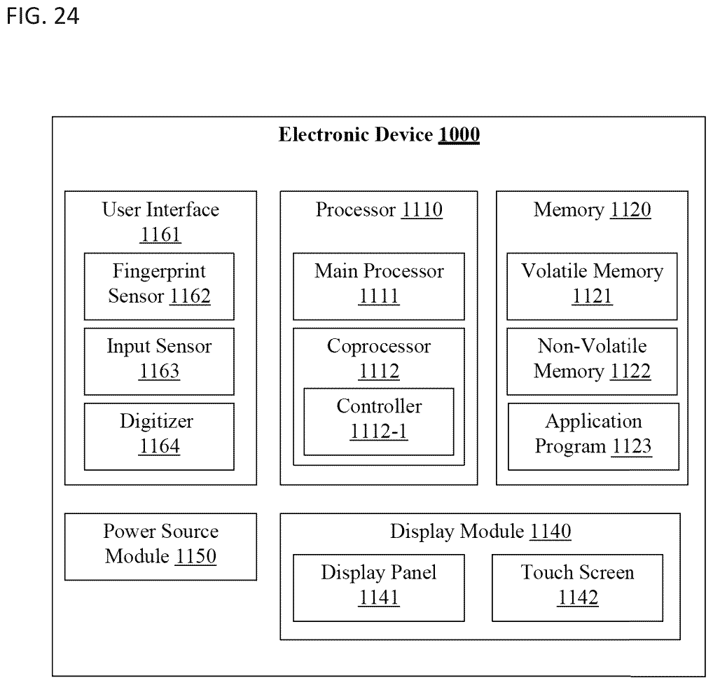

FIG. 24 is a diagram illustrating an electronic device according to an embodiment of the present invention. Referring to FIG. 24, the electronic device 1000 according to one embodiment of the present invention may output various information (e.g., images, text, music, etc.) through a display module 1140, which, for example, may correspond to the display device 290 shown in FIG. 1. When a processor 1110 executes an application stored in a memory 1120, the display module 1140 may provide application information to a user through a display panel 1141.

In some embodiments, the electronic device 1000 may be configured as a smartphone, camera, smart TV, monitor, smartwatch, tablet, automotive display, or AR/VR headset. For example, the electronic device 1000 may be a smartphone including a touch-sensitive display area DA for interaction and a non-display area NDA including sensors and circuits for enhanced functionality. For example, the electronic device 1000 may be a television or monitor including a large display area DA for high-resolution video playback and a non-display area NDA incorporating driving circuits or connectivity modules for external inputs. For example, the electronic device 1000 may be a smartwatch including a display area DA optimized for compact and high-clarity visuals and a non-display area NDA integrating biometric sensors for health monitoring. In some cases, the electronic device 1000 be an AR/VR headset.

In some embodiments, memory 1120 may store information such as software codes for operating an application program 1123. The application program 1123 may include a software designed to execute specific tasks or provide functionality to a user. The application program 1123 may operate under the control of the processor 1110 and utilizes data stored in the memory 1120 to deliver a wide range of features, such as productivity tools, multimedia streaming and playback, file or mail deliveries or communication services. The application program 1123 interacts seamlessly with the user interface 1161 or touch screen 1142, allowing a user to launch, navigate, and utilize the program through user inputs such as touch, tap, gesture, or voice interaction.

Upon user selection of an application via touch screen 1142 or user interface 1161, the processor 1110 may execute the application program 1123 corresponding to the selected application retrieved from the memory 1120 to perform functionalities of the application. For example, when a user selects a camera application by tapping the icon (or a camera application icon) presented on the display panel 1141, the processor 1110 activates a camera module. The processor 1110 may transmit image data corresponding to a captured image acquired through the camera module to the display module 1140. The display module 1140 may display an image corresponding to the captured image through the display panel 1141.

As another example, when a user wishes to make a phone call, the user taps the telephone icon displayed on the display module 1140, the processor 1110 may execute a phone application program stored in the memory 1120. A telephone keypad may be presented on the display panel 1141 for the user to enter a phone number to call.

As another example, the display module 1140 may be integrated into an electronic device 1000, such as a laptop computer, smart TV, or tablet. A user wishing to access a multimedia streaming application (e.g., to watch a music video or movie) can do so by tapping the corresponding icon. This action activates the application, allowing the user to view the streamed content.

The processor 1110 may include a main processor 1111 and an auxiliary or coprocessor 1112. The main processor 1111 may include a central processing unit (CPU). The main processor 1111 may further include one or more of a graphics processing unit (GPU), a communication processor (CP), and an image signal processor (ISP).

The coprocessor 1112 may include a controller 1112-1. The controller 1112-1 may include an interface conversion circuit and a timing control circuit. The controller 1112-1 may receive an image signal from the main processor 1111, convert the data format of the image signal to match the interface specifications with the display module 1140, and output image data. The controller 1112-1 may output various control signals to drive the display module 1140. For example, the controller 1112-1 may drive the display module 1140 to display the icon on the display screen suitable for selection by a user to cause execution of an application program 1123.

The memory 1120 may store one or more application programs 1123 and various data used by at least one component (for example, the processor 1110 or the user interface 1161) of the electronic device 1000 and input data or output data for commands related thereto. For example, a camera application program, a GPS application program, an augmented reality and virtual reality application program, and other application programs that can be executed by the processor 1110 upon selection of corresponding icons presented on the display screen (or display panel 1141) via the touch screen 1142 or user interface 1161 by the user. In addition, various setting data corresponding to user settings may be stored in the memory 1120. The memory 1120 may include volatile memory 1121 and non-volatile memory 1122.

The display module 1140 may output visual information (images) to the user. The display module 1140 may include the display panel 1141, a gate driver, the source driver, a voltage generation circuit, and a touch screen 1142. The display module 1140 may further include a window, a chassis, and a bracket to protect the display panel 1141. The display module 1140 may include at least a part of the configuration of the display device 290 shown in FIG. 1.

The user interface 1161 serves as the interaction medium between a user and the electronic device 1000. The user interface 1161 may detect an input by a part (e.g., finger) of a user's body or an input by a pen or a mouse, and generate an electric signal or data value corresponding to the input. The user interface 1161 includes the fingerprint sensor 1162, the input sensor 1163, and a digitizer 1164.

The fingerprint sensor 1162 may sense a fingerprint for biometric recognition of the user and may also measure one or more biological signals such as blood pressure, moisture, or body mass.

The input sensor 1163 may sense user interactions including touch, tap, gesture, motion, spoken command, and eye movement. The input sensor 1163 includes optical sensors for image capture, eye tracking, or motion and gesture detection. Optical sensors may be infrared or semiconductor photodetectors. The input sensor 1163 includes audio and acoustic sensors, which may be MEMS microphones for voice recognition or sound-based interaction. The audio and acoustic sensors can be installed as part of the user interface 1161 or embedded in the display panel 1141.

The digitizer 1164 may generate a data value corresponding to coordinate information of input by a pen or a mouse to control movement of an onscreen cursor. The digitizer 1164 may generate the amount of change in electromagnetic due to the input as the data value. The digitizer may detect an input by a passive pen or transmit and receive data with an active pen or a remote.

At least one of the fingerprint sensor 1162, the input sensor 1163, or the digitizer 1164 may be implemented as a sensor layer formed on the top layer of the display panel 1141 through a continuous process with a process of forming elements (for example, the light emitting element, the transistor, and the like) included in the display panel 1141.

In addition, the user interface 1161 may further include, for example, a gesture sensor, a gyro sensor that senses rotational movements, an acceleration sensor to track translational movement, a grip sensor, a pressure sensor, a proximity sensor, a color sensor, an infrared (IR) emitter and camera sensor for tracking gaze direction and eye movements, a temperature sensor, or a light sensor. For example, the gyro sensor, acceleration sensor, and infrared emitter and camera may be particularly suitable for AR/VR headset functions.

The touch screen 1142 includes touch sensors embedded in semiconductor layers of the display panel 1141 to sense pressure applied to the top layer (screen) of the display panel 1141. The touch sensors can be a capacitive or a resistive type. The touch screen 1142 may serve as the primary interface for the user to select and navigate applications, control, and interact with the electronic device 1000.

The display panel 1141 (or display) may include a liquid crystal display panel, an organic light emitting display panel, or an inorganic light emitting display panel, and the type of the display panel 1141 is not particularly limited. The display panel 1141 may be of a rigid type or a flexible type that can be rolled or folded. The display module 1140 may further include a supporter, bracket, heat dissipation member, and the like that support the display panel 1141. The display panel 1141 may include the display unit shown in FIG. 1.

The power source module 1150 may supply power to the components of the electronic device 1000. The power source module 1150 may include a battery that charges the power source voltage. The battery may include a non-rechargeable primary battery or a rechargeable secondary battery or fuel cell. The power source module 1150 may include a power management integrated circuit (PMIC). The PMIC may supply optimized power source to each of the components described above including the display module 1140.

It should be understood, however, that the aspects and features of embodiments of the present disclosure are not restricted to the one set forth herein. The above and other aspects of the present disclosure will become more apparent to one of ordinary skill in the art to which the present disclosure pertains by referencing the claims, with equivalents thereof to be included therein.

What is claimed is:

1. A display device comprising:
a display panel; and
an optical member disposed on the display panel,
wherein the optical member includes:
a base substrate;
a polarization control portion disposed on the base substrate and configured to receive light incident from the display panel and output the light with one of a first linear polarization direction and a second linear polarization direction;
a plurality of lenses disposed on the polarization control portion;
a black matrix disposed on the polarization control portion and in a space between two adjacent lenses of the plurality of lenses; and
a light reflection layer disposed between a side surface of the black matrix and each of the plurality of lenses, and
wherein a refractive index of the light reflection layer is lower than a refractive index of each of the plurality of lenses.

2. The display device of claim 1,
wherein a lower surface of the black matrix is wider than an upper surface of the black matrix.

3. The display device of claim 2,
wherein the side surface of the black matrix is a flat plane.

4. The display device of claim 3,
wherein a side surface of the light reflection layer is a flat plane.

5. The display device of claim 4,
wherein an angle between the side surface of the light reflection layer and the lower surface of the black matrix is 87° to 90°.

6. The display device of claim 1,
wherein the polarization control portion includes:
a first driving electrode disposed below the plurality of lenses;
a second driving electrode disposed below the first driving electrode;
a liquid crystal layer disposed between the first driving electrode and the second driving electrode; and
a polarizing member disposed below the second driving electrode and in contact with an upper surface of the display panel, and
wherein the polarizing member is configured to polarize the light incident from the display panel to have the first linear polarization direction.

7. The display device of claim 6,
wherein the liquid crystal layer includes a plurality of liquid crystal molecules,
wherein when a voltage difference between the first driving electrode and the second driving electrode is a predetermined value or less, long axes of the plurality of liquid crystal molecules are gradually aligned to from a first direction to a second direction perpendicular to the first direction between the first driving electrode and the second driving electrode,
wherein a long axis of at least one liquid crystal molecule, adjacent to the second driving electrode, of the plurality of liquid crystal molecules is aligned to the first direction,
wherein a long axis of at least one liquid crystal molecule, adjacent to the first driving electrode, of the plurality of liquid crystal molecules is aligned to the second direction, and
wherein the liquid crystal layer rotates the first linear polarization direction of the light incident from the display panel to the second linear polarization direction.

8. The display device of claim 7,
wherein when the voltage difference between the first driving electrode and the second driving electrode is greater than the predetermined value, the long axes of the plurality of liquid crystal molecules are aligned to a third direction perpendicular to the first direction and the second direction, and
wherein the polarizing member passes the light having the first linear polarization direction incident from the display panel so that a light outputted from the polarizing member has the first linear polarization direction.

9. The display device of claim 1,
wherein the display panel includes:
a substrate;
a thin film transistor layer disposed on the substrate;
a light emitting element layer disposed on the thin film transistor layer; and
an encapsulation layer disposed on the light emitting element layer.

10. A display device comprising:
a display panel; and
an optical member disposed on the display panel,
wherein the optical member includes:
a base substrate;
a polarization control portion disposed on the base substrate and configured to receive light incident from the display panel and output the light with one of a first linear polarization direction and a second linear polarization direction;
a plurality of lenses disposed on the polarization control portion;
a black matrix disposed on the polarization control portion and between the plurality of lenses; and
a light reflection layer disposed between a side surface of the black matrix and each of the plurality of lenses, and
wherein the light reflection layer includes a metal that reflects light.

11. The display device of claim 10,
wherein the side surface of the black matrix is a flat plane.

12. The display device of claim 10,
wherein a side surface of the light reflection layer is a flat plane.

13. The display device of claim 10,
wherein the side surface of the black matrix is a curved surface, and
wherein a side surface of the light reflection layer is a curved surface.

14. The display device of claim 13,
wherein a distance, in a first direction, between an upper side of the light reflection layer and a central axis of a first lens, adjacent to the light reflection layer, among the plurality of lenses is greater than a distance, in the first direction, between a lower side of the light reflection layer and the central axis of the first lens, and
wherein the first direction is parallel to an upper surface of the base substrate.

15. The display device of claim 14,
wherein an amount of increase in distance between a portion of the side surface of the light reflection layer and the central axis of the first lens decreases from the lower side to the upper side of the light reflection layer.

16. The display device of claim 13,
wherein a distance between an upper side of the light reflection layer and a central axis of a first lens, adjacent to the light reflection layer, among the plurality of lenses is the same as a distance between a lower side of the light reflection layer and the central axis of the first lens.

17. The display device of claim 16,
wherein the light reflection layer has a concave side surface which contacts the first lens,
wherein in a first direction, a central portion of the light reflection layer is a portion spaced apart from the upper and lower sides of the light reflection layer by the same distance, and
wherein a distance, in the first direction, between the central portion of the light reflection layer and the central axis of the lens is greater than the distance, in the first direction, between the upper side of the light reflection layer and the central axis of the first lens.

18. The display device of claim 10,
wherein each of the plurality of lenses includes a plurality of liquid crystal molecules each of which has a long axis aligned in a first direction which is parallel to an upper surface of the base substrate.

19. The display device of claim 18,
wherein the polarization control portion includes a polarizing member that polarizes the light incident from the display panel to have the first linear polarization direction.

20. An electronic device comprising:
a processor;
a memory having stored application programs for execution by the processor;
a display device,
wherein the display device includes
a display panel; and
an optical member disposed on the display panel,
wherein the optical member includes:
a base substrate;
a polarization control portion disposed on the base substrate and configured to receive light incident from the display panel and output the light with one of a first linear polarization direction and a second linear polarization direction;
a plurality of lenses disposed on the polarization control portion;
a black matrix disposed on the polarization control portion and in a space between two adjacent lenses of the plurality of lenses; and
a light reflection layer disposed between a side surface of the black matrix and each of the plurality of lenses, and
wherein a refractive index of the light reflection layer is lower than a refractive index of each of the plurality of lenses; and
a user interface configured to sense user input via touch or cursor select of an icon presented on the display panel,
wherein the processor is caused to execute one or more of the stored application programs upon receipt of the user input.
